(19) United States
(12) Patent Application Publication
(10) Pub. No.: US 2008/0276773 A1
(43) Pub. Date: Nov. 13, 2008

(54) Multipurpose cutting method for cutting various materials

(76) Inventor: Radhakrishna Shesha Iyengar Togare, Vancouver, WA (US)

Correspondence Address: Radhakrishna Togare;X on Labs, 3500 SE 175th Avenue, Vancouver, WA, 98683, US

(21) Appl. No.: 11/703,953

(22) Filed: Feb. 8, 2007

Related U.S. Application Data
(60) Provisional application No. 60/787,275, filed on Mar. 30, 2006.

(51) Int. Cl. B26D 1/00; B26D 1/14; B26D 5/08

(52) U.S. Cl. 83/34; 83/471.3; 83/581

(57) ABSTRACT

The present invention relates to a multipurpose cutting method, using a power tool, hereafter called “m Mach”, for cutting various materials. The tool (device) can be quickly configured to work as a straight-cutter, a cross-cutter, a compound miter cutter, a chop saw, a table saw, a straight-side creator, or a circular saw. It is to provide a new, improved and reliable multipurpose cutting device that can complement or eliminate the need of having more than one cutting power tool to perform various cutting functions.

### CROSS-REFERENCE TO RELATED APPLICATION

This application claims the benefit of U.S. provisional patent application Ser. No. 60/787,275 filed Mar. 30, 2006.

### FIELD OF THE INVENTION

The present invention relates to a multipurpose cutting method, using a power tool, hereafter called “m Mach”, for cutting various materials. The tool (device) can be quickly configured to work as a straight-cutter, a cross-cutter, a compound miter cutter, a chop saw, a table saw, a straight-side creator, or a circular saw. It is to provide a new, improved and reliable multipurpose cutting device that can complement or eliminate the need of having more than one cutting power tool to perform various cutting functions.

### BACKGROUND OF THE INVENTION

Cutting various materials using power tools having circular rotating blade is known for decades. With the invention of internal and external electric power sources and the subsequent advancement in technology, power tools employing circular rotating blade technology have become the commodities of every industry and household. In all such machines, a circular blade that is directly or indirectly driven by a motor cuts the workpiece linearly as per the requirement. The placement of the workpiece, the blade and the motor depends on the type of the cutting machine used. However, the workpiece is always cut in a straight line while making the required horizontal or vertical cutting angles to which the blade is set during the cutting operations.

There are various types of circular cutting machines available now-a-days. Each of which can perform specific functions, namely, circular power saw, miter saw, table saw, cross cut saw, chop saw, etc., to name a few. These machines are used to cut all types of materials such as wood, ferrous and non-ferrous metals, plastics, natural and artificial tiles and granites and many other items that can be cut using circular rotating blades. However, each of these machines is meant to perform only limited and specific function. For example, a miter saw can be used for cross cutting or miter cutting of materials of limited width at various horizontal and vertical angles while a table saw is meant for ripping various materials in lengths at various angles. A circular saw on the other hand is commonly used for cutting large materials where it is convenient to move the cutting machine rather than the workpiece itself. But, anyone who needs to use a circular blade cutting machine for more than one function has to depend on more than one type of machine. This results in personnel having several machines to carry out the required task and increased capital investment, real estate, under-utilization of a specific machine, transportation of more than one machine and so on.

### BRIEF DESCRIPTION AND SUMMARY OF THE INVENTION

This invention of m Mach cutting machine shown in the FIG. 1 generally relates to the circular cutting machines and the improvements thereto. This invention has been carried out with the aim of having a multipurpose power tool (device) that is not just a specific cutting machine but is a multi-function cutting machine that can replace or complement one or more machines. It helps in resolving many issues explained above to the best extent possible by incorporating multipurpose features and new techniques in just one machine. The uniqueness of this invention comes from the fact that the machine can be quickly configured to operate in many ways with ease. Depending on the requirement, the m Mach can be easily and quickly configured to work as a basic straight- or through-cutting machine, a cross cutting machine, a compound miter cutting machine, a chop saw, a table-saw, or a circular saw. In addition, the machine can also be used as a straight-side creator for creating straight-side for a workpiece or a sheet of material that does not have at least one straight side, which is normally needed for biasing the workpiece against a fence to perform various cutting operations on such workpieces.

With this, not only the m Mach can be used to perform to the fullest extent possible but also it can be used to perform many other tasks that other machines are not capable of. This machine is intended for cutting all types of materials such as wood, ferrous and non-ferrous metals, plastics, natural and artificial tiles and stones (granites), MDF (Medium Density Fiber) and all other items that can be cut using circular rotating blades.

Further increase in the performance of the m Mach can be achieved with the use of easy to use simple attachments explained in detail in this document. Most of the attachments described in this document can be permanently integrated within the machine or easily added or separated while on the job.

### BRIEF DESCRIPTION OF THE DRAWINGS

FIG. 1 shows the front elevation view of m Mach multipurpose cutting machine in its basic configuration.

FIG. 2 shows the rear elevation view of m Mach cutting machine in its basic configuration.

FIG. 3 shows the top plan view of m Mach cutting machine in its basic configuration.

FIG. 4 shows the left side elevation view of m Mach cutting machine shown in FIG. 5.

FIG. 5 shows the front elevation view of m Mach cutting machine in its basic configuration.

FIG. 6 shows the right side elevation view of m Mach cutting machine shown in FIG. 5.

FIG. 7 shows the bottom plan view of m Mach cutting machine in its basic configuration.

FIG. 8 shows the front elevation view of m Mach, which is ready for use. The auto-retractable blade-guard is lifted when the machine is pressed down if the depress lock is kept unlocked.

FIG. 9 shows the rear elevation view of m Mach, which is ready for use. The auto-retractable blade-guard is lifted when the machine is pressed down if the depress lock is kept unlocked.

FIG. 10 shows the top plan view of m Mach, reproduced from FIG. 3.

FIG. 11 shows the rear elevation view of m Mach, reproduced from FIG. 9.

FIG. 12 shows the top plan view of m Mach main platform with bevel receptacle present at both ends.

FIG. 12a shows the enlarged cross sectional view of main platform (shown in FIG. 12) between A-A′ and B-B′, seen from A-A′.

FIG. 13 shows the turn-around (revolving) miter fence used in m Mach, generally identified by element (item) 2.

FIG. 14 shows the manually retractable screw clamps that are used to firmly hold the material during all cutting operations. The clamps are screwed into the threaded holes located on the platform specially meant for screw clamps.

FIG. 15 shows the front elevation view of m Mach, reproduced from FIG. 8.

FIG. 16 shows the front elevation view of main platform of m Mach with bevel receptacle present at both the ends.

FIG. 17 shows the rear elevation view of main platform of m Mach with bevel receptacle present at both the ends.

FIG. 18 shows the top plan view of main platform of m Mach with bevel receptacle present at both the ends.

FIG. 18a shows the enlarged cross sectional view of main platform (with extension support rod fastened) shown in FIG. 18 between A-A′ and B-B′, seen from A-A′.

FIG. 19 shows the front elevation view of main platform of m Mach with bevel receptacle present at both the ends.

FIG. 20 shows the front elevation view of extension platform of m Mach (that has been pulled out from the underneath of main platform) with its manually retractable platform wheels unfolded.

FIG. 21 shows the top plan view of extension platform of m Mach (that has been pulled out from the underneath of main platform).

FIG. 22 shows the top plan view of extension platform of m Mach, reproduced from FIG. 21.

FIG. 22a shows the enlarged cross sectional view of extension platform shown in FIG. 22, seen from C-C′.

FIG. 22b shows the enlarged cross sectional view of extension platform shown in FIG. 22, seen from D-D′.

FIG. 23 shows the manually retractable screw clamps that can be used to firmly hold the material during all cutting operations. The clamps are screwed into the threaded holes located on the platform specially meant for screw clamps.

FIG. 24 shows the m Mach configured to work as a table saw with its rip fence firmly clamped to both main and extension platforms.

FIG. 25 shows the front elevation view of m Mach, which is ready for use, with its auto-retractable blade-guard lifted when the machine is pressed down. The depress lock can be kept locked or unlocked.

FIG. 26 shows the top plan view of m Mach main platform with bevel receptacle present at both ends.

FIG. 26a shows the front elevation view of turn-around miter fence that is fitted onto the semi-circular slots of the main platform shown in FIG. 26.

FIG. 26b shows the rear elevation view of the turn-around miter fence with its fasteners and base plate separated for clarity.

FIG. 26c shows the quick tight fasteners used to fasten the turn-around miter fence to the main platform.

FIG. 26d shows the miter base plate that holds the turn-around miter fence from the underneath of the platform when the miter fence is fastened to the miter base plate with the help of the quick-tight fasteners shown in FIG. 26c.

FIG. 27 shows the left side (home-end) elevation view of m Mach with the bevel cutting angle set at normal angle (0°) position.

FIG. 27a shows the enlarged, left side (home-end) elevation view of m Mach with the bevel cutting angle set at normal angle (0°) position.

FIG. 28 shows the front elevation view of m Mach, which is ready for use, with its auto-retractable blade-guard lifted when the machine is pressed down. The depress lock can be kept locked or unlocked.

FIG. 29 shows the right side (dead-end) elevation view of m Mach with the bevel cutting angle set at normal angle (0°) position.

FIG. 29a shows the enlarged, right side (dead-end) elevation view of m Mach with the bevel cutting angle set at normal angle (0°) position.

FIG. 30 shows the left side (home-end) elevation view of m Mach with the bevel cutting angle set at a positive angle position.

FIG. 31 shows the right side (dead-end) elevation view of m Mach with the bevel cutting angle set at a positive angle position.

FIG. 32 shows the left side (home-end) elevation view of m Mach with the bevel cutting angle set at a negative angle position.

FIG. 33 shows the right side (dead-end) elevation view of m Mach with the bevel cutting angle set at a negative angle position.

FIG. 34 shows the top plan view of main platform of m Mach with bevel receptacle present at both ends.

FIG. 34 shows the top plan view of extension platform of m Mach.

FIG. 36 shows the main engine of m Mach kept in depressed position. The blade guard and depress lock are set in locked position. This is also the condition under which the machine can be safety transported.

FIG. 37 shows the main engine of m Mach that ready for use.

FIG. 38 shows the main engine of m Mach that is ready to cut the material when the power is supplied to the engine.

FIG. 39 shows different type of engines (and their variations thereof) that can be used in m Mach.

FIG. 40 shows the m Mach engine driven in forward direction (also called, normal driving).

FIG. 41 shows the m Mach engine driven in reverse direction (also called, reverse driving).

FIG. 42 shows the material being cut by a forward driven engine.

FIG. 43 shows the material being cut by a reverse driven engine.

FIG. 44 shows the front-view of the Main engine of m Mach.

FIG. 45 shows the enlarged view of SmartMech (also called, “Integrated slider-cum-multifunction mechanism”) separated from the main engine shown in FIG. 44.

FIG. 46 shows the front elevation view of sub-engine, separated from the main engine.

FIG. 47 shows the rear elevation view of m Mach that is ready for use.

FIG. 48 shows the “Integrated Slider” portion of the SmartMech of m Mach, identified by 66.

FIG. 49 shows the top assembly portion of the SmartMech of m Mach, identified by 68.

FIG. 50 shows the SmartMech of m Mach retracted to its maximum height when slowly released while it is controlled and held by the pivot mechanism.

FIG. 50a shows the enlarged cross sectional view of SmartMech shown in FIG. 50 seen from E-E′, with the TwistMech lock-pin (that is integrated with the ball plunger) pulled-out to its maximum. This will unlock the Twisting mechanism that is within the SmartMech.

FIG. 50b shows the enlarged cross sectional view of SmartMech shown in FIG. 50 seen from E-E′, with the TwistMech lock-pin (that is integrated with the ball plunger) completely pushed-in. This will lock the Twisting mechanism that is within the SmartMech.

FIG. 51 shows the main engine of m Mach kept in depressed position. The blade guard and depress lock are set in locked position. This is also the condition under which the machine can be safety transported.

FIG. 52 shows the main engine of m Mach that is ready for use.

FIG. 53 shows the main engine of m Mach that is fully depressed and ready to cut the material when the power is supplied to the engine.

FIG. 54 shows the m Mach cutting the material when it is manually moved from one end to the other.

FIG. 55 shows the DalMech (also called “Depress and Lift-up mechanism”) set at normal position.

FIG. 56 shows the DalMech (also called “Depress and Lift-up mechanism”) lifted-up completely.

FIG. 57 shows the DalMech (also called “Depress and Lift-up mechanism”) depressed completely.

FIG. 58 shows the top plan view of main platform of m Mach with bevel receptacle present at both ends.

FIG. 59 shows the main engine of m Mach set at home position (0°) to drive it in forward driving mode.

FIG. 60 shows the Main engine of m Mach set at −90° (or +270°) to use the m Mach as a table saw.

FIG. 61 shows the Main engine of m Mach set at +90° to use the m Mach as a table saw.

FIG. 62 shows the Main engine of m Mach set at 180° to drive it in reverse driving mode.

FIG. 63 shows the main engine of m Mach kept in depressed position. The blade guard and depress lock are set in locked position. This is also the condition under which the machine can be safety transported.

FIG. 64 shows the Integrated slider-cum-bevel receptacle portion of the SmartMech. The bevel receptacle portion of the SmartMech is identified by 67.

FIG. 65 shows the Top assembly portion of the SmartMech. The top assembly portion of the SmartMech is identified by 68.

FIG. 66 shows the TwistMech (also called, Engine twisting mechanism), identified by 82, that is integrated within the SmartMech.

FIG. 66a shows the enlarged cross sectional view of TwistMech portion of the SmartMech shown in FIG. 66 seen from E-E′. The TwistMech lock-pin (that is integrated with the ball plunger) is pulled-out to its maximum to unlock the Twisting mechanism that is within the SmartMech.

FIG. 66b shows the enlarged cross sectional view of TwistMech portion of the SmartMech shown in FIG. 66, seen from E-E′. The TwistMech lock-pin (that is integrated with the ball plunger) is completely pushed-in to lock the Twisting mechanism that is within the SmartMech.

FIG. 67 shows the SmartMech with its TwistMech set at −90° (or +270°) to use the m Mach as a table saw.

FIG. 68 shows the SmartMech with its TwistMech set at +90° to use the m Mach as a table saw.

FIG. 69 shows the SmartMech with its TwistMech set at 180° to drive the m Mach's engine in reverse driving mode.

FIGS. 70-72 show the SmartMech with its StretchMech (identified by 83) stretched horizontally at different lengths (D) irrespective of the status of other mechanisms within SmartMech 6.

FIGS. 73-75 show the StretchMech (identified by 83) portion of the SmartMech showing the horizontal stretching at different lengths (D).

FIG. 76 shows the engine of m Mach that is ready to cut when the power is supplied to it.

FIG. 77 shows the Top plan view of the extension platform of m Mach.

FIG. 78 shows the enlarged view of SmartMech.

FIG. 79 shows the enlarged view of IR (insert-release) pins that are used to hold the sub-engine when it is mounted on SmartMech.

FIG. 80 shows the sub-engine of m Mach. Sub-engine is identified by the absence of SmartMech from the main-engine.

FIG. 81 shows the sub-engines (Type A-D) of m Mach that can be readily used as circular saw when it is attached with the snap-in “Integrated handle with bevel-cum-cutting depth adjustment” attachment.

FIG. 82 shows the “Integrated handle with bevel-cum-cutting depth adjustment” attachment, identified by 89, that can be attached to the sub-engines (Type A-D) of m Mach to use sub-engine as a circular saw.

FIG. 83 shows the sub-engines (Type A-D) of m Mach setup to work as circular saw with the use of “Integrated handle with bevel-cum-cutting depth adjustment” attachment.

FIGS. 84-87 show the main engine of m Mach with its Croc-lever (also called, Crocodile lever) under different operating conditions.

FIG. 88 shows the Croc-lever (also called, Crocodile lever) and the Croc-pin (also called, Crocodile pin) of m Mach in different views. The pin is pulled-out to its maximum to adjust the Croc-lever and pushed-in once the adjustment is made.

FIG. 89 shows the sub-engines (Type A-D) of m Mach.

FIG. 90 shows the “Integrated handle with bevel-cum-cutting depth adjustment” attachment used to convert the m Mach sub-engine to a circular saw.

FIG. 91 shows the sub-engines of m Mach configured to work as circular saw. The auto-retractable blade guard is lifted-up to show the circular blade.

FIG. 92 shows the main engine of m Mach that is ready to cut the material when the power is supplied to the engine.

FIG. 93 shows the enlarged, left side (home-end) elevation view of m Mach with the bevel cutting angle set at normal angle (0°) position.

FIG. 94 shows the right side (dead-end) elevation view of m Mach with the bevel cutting angle set at normal angle (0°) position.

FIG. 95 shows the guide rail of m Mach on which the main engine is made to slide by pushing or pulling the engine with the help of the handle connected to the engine at a convenient place.

FIG. 96 shows the guide rail of m Mach with the extension support rod stowed and fastened inside the hollow tube of the guide rail when the support rod is not in use.

FIG. 97 shows the stowed-in support rod taken out of guide rail to provide additional support for large workpieces during cutting operations.

FIG. 98 shows the engine stoppers shown on the guide rail(s) to stop the engine at a desired position on the guide rail(s).

FIG. 99 shows the engine stoppers shown on the guide rail(s) to stop the engine from wobbling when the m Mach is used in circular saw configuration.

FIG. 100 shows the top plan view of m Mach.

FIG. 101 shows the top plan view of the extension platform used in m Mach.

FIG. 102 shows the engine of m Mach driven in the forward driving mode to explain the operation of the engine decelerators.

FIG. 103 shows the engine of m Mach driven in the reverse driving mode to explain the operation of the engine decelerators.

FIG. 104 shows the top plan view of m Mach to explain the operation of the engine decelerators.

FIG. 105 shows the engine decelerator used in m Mach to decelerate and stop the engine when the engine is moved to the either ends of the machine.

FIG. 106 shows the bevel plate of m Mach showing the threaded hole into which the engine decelerator is fastened.

FIG. 107 shows the m Mach table saw with rip fence clamped on to the main and extension platforms.

FIG. 108a shows the cross sectional view of m Mach table saw (FIG. 107) between D-D′ and E-E′ and seen from D-D′ to show the clamping and unclamping of the rip fence.

FIG. 108b shows the cross sectional view of m Mach table saw (FIG. 107) between D-D′ and E-E′ and seen from D-D′ showing the rip fence clamped to both main and extension platforms.

FIG. 109 shows the front elevation view of m Mach table saw.

FIG. 110 shows the top plan view of extension platform of m Mach.

FIG. 111 shows the engine blade aligner used for quick and accurate setup of the m Mach in Table saw configuration.

FIG. 112 shows the top plan view of the extension platform showing the placement of the engine blade aligner for quick and accurate setup of the engine blade when m Mach is used in table saw configuration.

FIG. 112a shows the cross sectional view of the extension platform of FIG. 110 seen from D-D′ showing the details of platform and kerf plate linear groves.

FIG. 112b shows the cross sectional view of the extension platform of FIG. 112 seen from D-D′ showing the engine blade alignment with the use of the blade aligner.

FIG. 113 shows the front elevation view of m Mach setup to work as a table saw with dead-end bevel mechanism present while the slider is kept at home position.

FIG. 114 shows the front elevation view of m Mach setup to work as a table saw with dead-end bevel mechanism absent to extend the operation. Notice the slider support moved away from its home position.

FIG. 115 shows the front elevation view of Slider support shown in FIG. 114.

FIG. 116 shows the front elevation view of m Mach table saw showing the use of optional blade guard.

FIG. 117a shows the front elevation view of optional blade guard that can be used when the m Mach is used as a table saw.

FIG. 117b shows the side elevation view of optional blade guard shown in FIG. 117a.

FIG. 118 shows the enlarged view of m Mach engine with its blade guard lifted.

FIG. 119 shows the enlarged front elevation view of m Mach (blade guard removed for the explanation) showing the possible placement of laser equipment to generate straight laser line before and during the cutting operation in all modes.

FIG. 120 shows the m Mach engine fitted with the dust collection tube.

FIG. 121 shows the m Mach engine fitted with a dust collection bag.

FIG. 122 shows the m Mach fitted with the dust collection tube underneath the SmartMech.

FIG. 123 shows the combination dust collection tube when contracted.

FIG. 124 shows the combination dust collection tube when stretched.

FIG. 125 shows the front elevation view of m Mach with its engine cutting the workpiece in forward driving mode.

FIG. 126 shows the front elevation view of m Mach with its engine cutting the workpiece in reverse driving mode.

FIG. 127 shows the top plan view of m Mach being used as a straight cutter with its laser line turned ON and the engine is in forward driving mode.

FIG. 128 shows the top plan view of m Mach being used as a straight cutter with its laser line turned ON and the engine is in reverse driving mode.

FIG. 129 shows the top plan view of m Mach being used as a compound miter cutter with its laser line turned ON and the engine is in forward driving mode.

FIG. 130 shows the top plan view of m Mach being used as a compound miter cutter with its laser line turned ON and the engine is in reverse driving mode.

FIG. 131 shows the m Mach configured as a table saw with its engine set at −90° (or +270°) position.

FIG. 132 shows the m Mach configured as a table saw with its engine set at +90° position.

FIG. 133 shows the top plan view of m Mach (FIG. 131) configured as a table saw with its engine set at −90° (or +270°) position.

FIG. 134 shows the top plan view of m Mach (FIG. 132) configured as a table saw with its engine set at +90° position.

FIG. 135 shows the top plan view of m Mach (FIG. 133) configured as a table saw with its engine set at −90° (or +270°) position and the extension platform twisted by 180°.

FIG. 136 shows the top plan view of m Mach (FIG. 134) configured as a table saw with its engine set at +90° position and the extension platform twisted by 180°.

FIG. 137 shows the blade aligner used for quick and accurate setting of engine blade to configure m Mach as a table saw.

FIG. 138 shows the m Mach sub-engines (Type A-D) configured to work as circular saw with the use of “Integrated handle with bevel-cum-cutting depth adjustment” attachment shown in FIG. 139.

FIG. 139 shows the “Integrated handle with bevel-cum-cutting depth adjustment” attachment that is used with the m Mach sub-engines (Type A-D) to configure the sub-engine as circular saw as shown in FIG. 138.

FIG. 140 shows the front elevation view of m Mach with its engine cutting the workpiece in forward driving mode.

FIG. 141 shows the front elevation view of m Mach with its engine cutting the workpiece in reverse driving mode.

FIG. 142 shows the m Mach being used as a straight or through cutter to cut the workpiece when the engine is in forward driving mode.

FIG. 143 shows the m Mach being used as a straight or through cutter to cut the workpiece when the engine is in reverse driving mode.

FIG. 144 shows the m Mach being used as a reference side creator (also called, reference side generator) to create a straight side on a workpiece that does not have at-least one straight side. The engine is in forward driving mode.

FIG. 145 shows the m Mach being used as a reference side creator (also called, reference side generator) to create a straight side on a workpiece that does not have at-least one straight side. The engine is in reverse driving mode.

FIG. 146 shows the m Mach being used as a cross cutter to cut the workpiece when the engine is in forward driving mode. The extension support rods and the leveler are used for additional support for the workpiece

FIG. 147 shows the m Mach being used as a cross cutter to cut the workpiece when the engine is in reverse driving mode. Both extension support rods and extension platform are used for additional support for the workpiece.

FIG. 148 shows the m Mach being used as a compound miter cutter set at a positive angle to cut the workpiece when the engine is in forward driving mode. The extension platform is used for additional support for the workpiece.

FIG. 149 shows the m Mach being used as a compound miter cutter set at a positive angle to cut the workpiece when the engine is in reverse driving mode. The extension support rods and the levelers are used for additional support for the workpiece

FIG. 150 shows the m Mach being used as a compound miter cutter set at a negative angle to cut the workpiece when the engine is in forward driving mode.

FIG. 151 shows the m Mach being used as a compound miter cutter set at a negative angle to cut the workpiece when the engine is in reverse driving mode.

FIG. 152 shows the front elevation view of m Mach cutting a workpiece.

FIG. 153 shows the left-side (home-end) elevation view of m Mach with its bevel mechanism set at normal (0°) cutting angle.

FIG. 154 shows the left-side (home-end) elevation view of m Mach with its bevel mechanism set at a positive cutting angle.

FIG. 155 shows the left-side (home-end) elevation view of m Mach with its bevel mechanism set at a negative cutting angle.

FIG. 156 shows the m Mach configured as a table saw with its engine set at −90° (or +270°) position.

FIG. 157 shows the m Mach configured as a table saw with its engine set at +90° position.

FIG. 158 shows the m Mach table saw (with its engine set at −90°) cutting the workpiece.

FIG. 159 shows the m Mach table saw (with its engine set at −90°) cutting the workpiece. The extension platform is offset to the right from its normal position.

FIG. 160 shows the m Mach table saw (with its engine set at +90°) cutting the workpiece.

FIG. 161 shows the m Mach table saw (with its engine set at +90°) cutting the workpiece. The extension platform is offset to the left from its normal position.

FIG. 162 shows the sub-engine of m Mach used as a circular saw with its blade depth set at normal height.

FIG. 163 shows the sub-engine of m Mach used as a circular saw with its blade depth set at lower height for cutting thin workpiece.

FIG. 164 shows the sub-engine used as a circular saw with its blade beveled at an angle and the blade depth set at lower level.

FIG. 165 shows the “Integrated handle with bevel-cum-cutting depth adjustment” attachment used to convert the m Mach sub-engine to a circular saw.

FIG. 166 shows the front elevation view of m Mach with its length extended by adding the extension platform to increase the cutting length of the machine.

FIG. 167 shows the top plan view of m Mach with its length extended by adding the extension platform to increase the cutting length of the machine.

FIG. 168 shows the front elevation view of m Mach being used in extended operation mode for cutting a long workpiece.

FIG. 169 shows the top plan view of m Mach being used in extended operation mode, with its engine driven in forward direction, for cutting a long workpiece.

FIG. 170 shows the top plan view of m Mach being used in extended operation mode, with its engine driven in reverse direction, for cutting a long workpiece.

FIG. 171 shows the front elevation view of m Mach configured as a table saw with its dead-end bevel mechanism removed for extended operation. Additional support for the engine and the guide rails is provided by the slider.

FIG. 172 shows the side elevation view of slider support used for supporting the engine and the guide rails when the dead-end bevel mechanism is absent.

FIG. 173 shows the front elevation view of slider support (shown in FIG. 174) used for supporting the engine and the guide rails when the dead-end bevel mechanism is absent.

FIG. 174 shows the top plan view of m Mach configured as a table saw with its dead-end bevel mechanism removed for extended operation. The engine is set at −90° (or +270°) position.

FIG. 175 shows the top plan view of m Mach configured as a table saw with its dead-end bevel mechanism removed for extended operation. The engine is set at +90° position.

FIG. 176 shows the top plan view of m Mach configured as a table saw to work in extended mode to cut large sheets. The engine is set at −90° (or +270°) position.

FIG. 177 shows the top plan view of m Mach configured as a table saw to work in extended mode to cut large sheets. The engine is set at +90° position.

FIG. 178 shows the extension support rods (that are normally used for workpiece support) screwed into the threaded holes of m Mach and used as to increase the height of the machine.

FIG. 179 shows m Mach on a table.

FIG. 180 shows the foldable stand that can be manually folded or unfolded as per the requirement.

FIG. 181 shows the m Mach mounted on a separate stand.

### DETAILED DESCRIPTION AND THE BEST MODE OF THE INVENTION

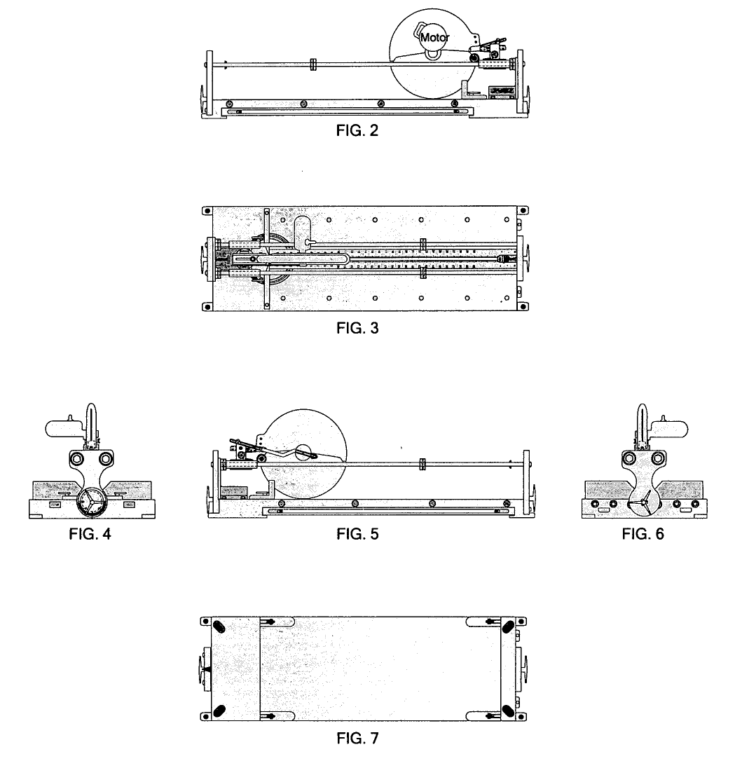

Since the m Mach is meant to operate in different configurations, an overall view of the machine will help to understand the concept behind this invention before the machine is explained in detail. FIGS. 2-7 show different views of m Mach in its basic configuration. This is also the configuration under which the m Mach can be safely transported.

This document explains in detail on configuring the m Mach in different ways to perform various cutting functions. It also explains the operation modes of m Mach in each of the configurations. When configured, the m Mach can work as a basic straight- or through-cutting machine, a cross cutting machine, a compound miter cutting machine, a table-saw or a circular saw. In addition, the machine can also be used as a straight-side creator for creating straight-sides for a workpiece for a sheet of material that does not have at-least one straight side, which is normally needed for biasing the workpiece against a fence to perform various cutting operations on such workpieces.

The m Mach is intended for cutting all types of materials such as wood, ferrous and non-ferrous metals, plastics, natural and artificial tiles and granites, MDF (Medium Density Fiber) and many other items that can be cut using circular rotating blades.

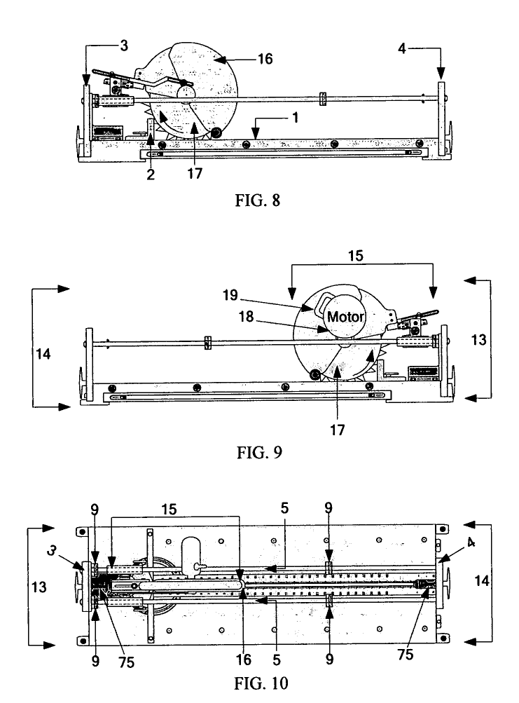

FIG. 8-9 shows the front and rear elevation views of the m Mach cutting machine, which is also called the machine, and identified hereafter by 50. The auto-retractable blade guard 16 that covers the cutting blade 17 for safety has been lifted-up by depressing the main engine 15. At its minimum, the m Mach 50 has a stable platform 1, also called the main platform 1, a revolving miter fence 2, a permanently fastened bevel mechanism 3 attached to the left-end (home-end 13) of the platform 1 and a removable bevel mechanism 4 attached to the right-end (dead-end 14) of the platform 1. One or more parallel guide rails 5 are fastened to the bevel mechanisms (3 and 4) on which the main engine 15 slides when it is moved with the help of the handle 19.

Underneath the main platform 1, an extension platform 7 is stowed-in when it is not in use. The extension platform 7 is used to setup the machine 50 in various operating modes or to perform various cutting operations on large workpieces. The extension platform 7 can be connected to the either side of the main platform 1 to extend the width of the main platform 1. The extension platform 7 can also be connected to the dead-end 14 of the main platform 1 to extend the dead-end 14 and hence the cutting length of the machine 50.

Turning attention to the rear elevation view of m Mach 50, the main engine 15 consists of an integrated slider-cum-multifunction mechanism 6, also called the SmartMech 6 and a motor 18 assembly. The SmartMech 6 is also used to configure the engine 15 in different operating modes. The motor 18 assembly of the main engine 15 includes one or more motors 18 to drive the circular blade 17. The motor 18 may be either directly or indirectly coupled to the circular blade 17. Typically, the motor 18 assembly directly drives the circular blade 17, also called, the cutting blade 17 or blade 17. The power to the engine 15 can be supplied from an external source such as line current or an internal source such as battery or a combination of both. Type of the source does not matter so long it is capable of driving the electric motor 18 of the main engine 15. The motor 18 can have the electric brake(s) as needed.

FIG. 10 shows top plan view of the m Mach cutting machine 50. The home-end 13 of the machine 50 is the normal resting place for the main engine 15 or simply called, engine 15. The dead-end bevel mechanism 4 limits the engine 15 from traveling beyond the dead-end 14 during normal cutting operations. The sliding engine stoppers 9 normally located on the guide rails 5 are used to stop the engine 15 from moving beyond the set point by the engine stopper 9. When not is use, the engine stoppers 9 are normally parked on either ends of the guide rails 5. The engine stoppers 9 can also be used as reference points to decide the end points of the cutting.

The inner side wall of both the bevel mechanisms (3 and 4) is fitted with the decelerator 75 to decelerate the engine 15 when the blade guard 16 of the engine 15 comes near the bevel mechanism (3 or 4) when it is pulled towards either end (13 or 14). The decelerator 75 can be made up of a compression type spring, rubber, hydraulic or pneumatic type.

### Main Platform

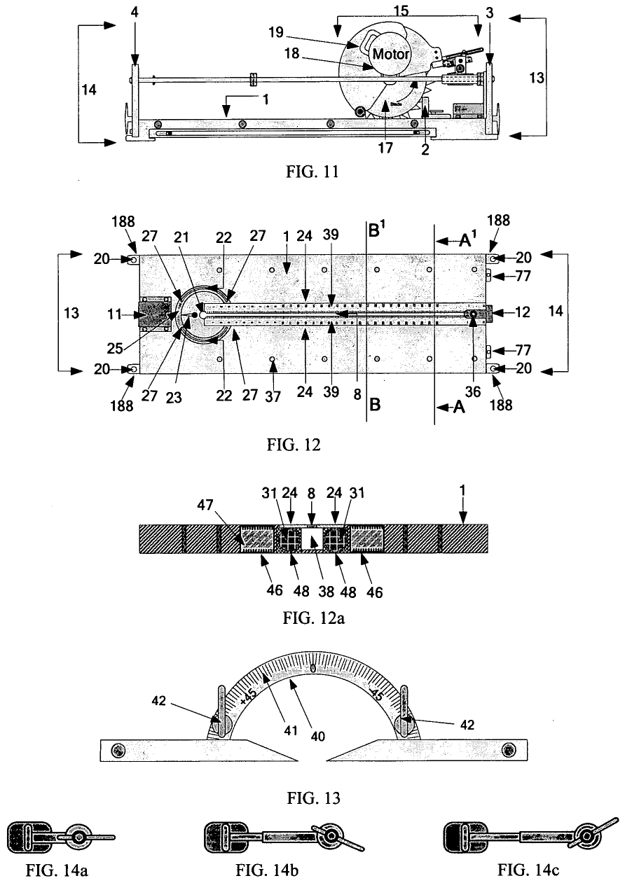

Refer to FIGS. 11-14c. The home-end 13 of the platform 1 is fitted with the home-end bevel receptacle 11 which is a part of the home-end bevel mechanism 3. The dead-end 14 of the platform 1 is fitted with the dead-end bevel receptacle 12, which is a part of the dead-end bevel mechanism 4. Both the bevel receptacles (11 and 12) help in beveling the rest of the bevel mechanisms (3 and 4) as per the set bevel angle. Since the end of guide rails 5 are connected to both the bevel mechanisms (3 and 4), it results in beveling of the engines (15) blade 17 that is proportional to the bevel angle being set. While the home-end bevel mechanism 3 is permanently fixed onto the platform 1, the dead-end bevel mechanism 4 can be completely taken out of the platform 1 by unscrewing the fastener 36 located on the platform 1 to operate the m Mach 50 in different modes.

To enable the cutting of the material in required horizontal angles while it is firmly biased against the stable, perfect edge, the main platform 1 accommodates for a unique turn-around miter fence 2, which also called the revolving miter fence 2. For this, the main platform 1 has a circular ring 25 with a pair of semicircular slot 22 exactly facing each other to fasten the miter fence 2 that is set at any angle. The semicircular slots 22 ensure that the miter fence 2 always stays within the designated circular path when the miter fence 2 is turned around in its own axis. The miter fence 2 can be turned around in both positive and negative angles (less than 90° on both sides) until the fence 2 is stopped by the end point 27 of the semicircular slots 22. A stationary reference pointer 23 located on the main platform 1 identifies the positive and negative angular movement of the semicircular ring 40 of the miter fence 2 that is marked with the required miter scale 41 for both positive and negative miter angles. The main platform 1 also has series of threaded holes 37 on top of it to fasten the manually stretchable, spring loaded or any other type of screw clamps similar to the ones shown in (FIG. 14a-c). The screw clamps are used to firmly hold the workpiece during various cutting operations. All the four corners of the platform 1 have the foot 188 with fastener holes 20 for securing the machine 50 on a table, surface, stand or any other type of base.

To enable the traveling of the cutting blade 17 in the designated path to cut the material, the main platform 1 has a linear grove 38. A kerf plate 24 is mounted on the surface of the platform 1 to protect the platform 1 and the sides of the linear grove 38 from touching by the cutting blade 17. The kerf plate 24 mounted on the surface of the platform 1 itself has a linear grove 8 that is sufficiently sized to receive a saw blade 17. Both linear groves (8 and 38) extend from the center point 21, which is also the turn-around axis of the miter fence 2, to the dead-end 14 of the platform 1. The rotating circular blade 17, directly or indirectly driven by an electric motor 18, is manually moved linearly within the linear grove 8 of the kerf plate 24 with the help of the handle 19 connected to the engine 15 to cut the workpiece. The circular blade 17 does not make any physical contact to the linear grove 8 of the kerf plate 24 or the main platform 1 underneath it under any operating conditions and at all the times. The linear scale 39 marked on the kerf plate 24 helps in quick marking and cutting of the material to the required size without using an additional tape measure.

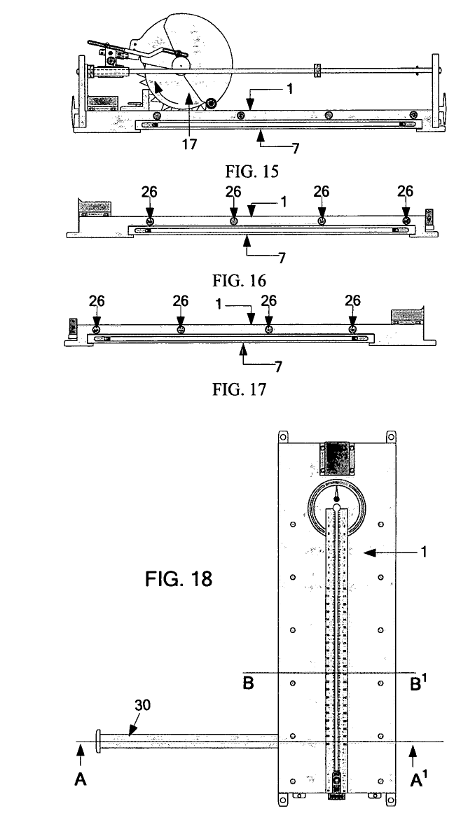

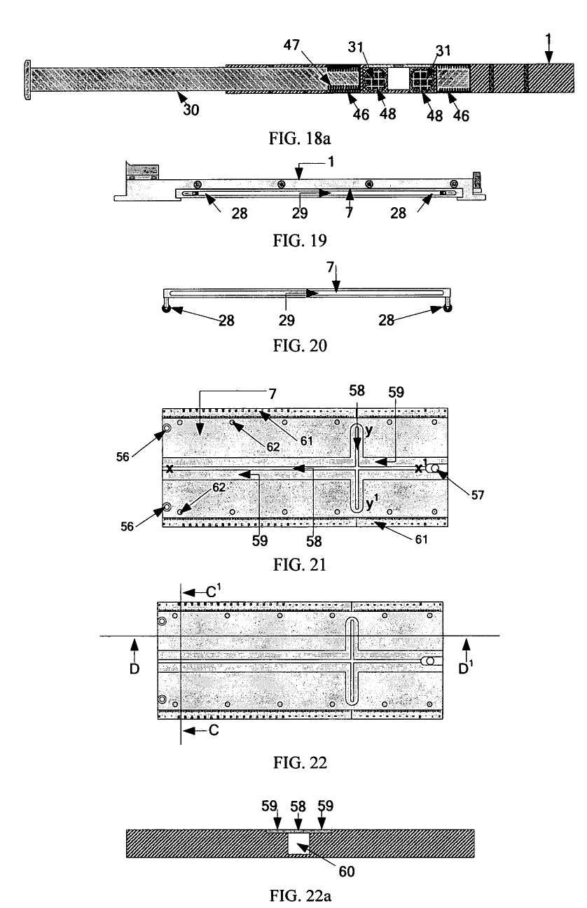

Refer to FIGS. 15-18a. Both front side and rear side of the main platform 1 have several circular holes 26. The circular holes 26 are meant for firmly holding the extension support rods 30, as shown in FIG. 20b that are used for supporting long and/or large workpieces. The innermost portion of the circular hole 26 is threaded 46 to accommodate for the threaded-end 47 of the extension support rod 30. The circular holes 26 are also meant for fastening the extension platform 7 on either side of the main platform 1 when needed in different configurations. The circular holes 26 extend from the side of the main platform 1 and terminate perpendicularly slightly before the linear area reserved for stowing the extension guide rails 31. The stowing of extension guide rails 31 in a circular hole 48 underneath the main platform 1 along the linear grove 38 but slightly away from it ensures no obstruction to circular blade 17 by the threaded-in extension support rods 30 during cutting operations. With this, it is not necessary to take out the extension platform 7 or the extension guide rails 31 stowed underneath the main platform 1 in order to use the extension support rods 30.

### Extension Platform

Refer to FIGS. 19-21. In order to operate the m Mach 50 to the full extent and effectively, m Mach 50 comes with an extension platform 7. Though, the extension platform 7 for m Mach 50 can be incorporated in several ways, including integrating it within the main platform's (1) design, only the sliding type extension platform 7 is described in this document for the explanation of the best mode of the invention.

The sliding extension platform 7 is normally stowed underneath the main platform 1 when it is not in use. When needed, the extension platform 7 can be easily pulled out from either side of the main platform 1 and fastened in parallel with the main platform 1 on either side.

The linear slot 29 on both sides of the extension platform 7 are used for sliding the extension platform 7 from end-to-end when it is held in parallel with the main platform 1 before it is completely fastened to the main platform 1. A pair of manually retractable wheels 28 underneath the extension platform 7 on each end also provides the required support to the extension platform 7 while the extension platform 7 is being aligned in parallel with the main platform 1. The wheels are locked once the alignment of the extension platform 7 is made for the safe operation of the m Mach 50.

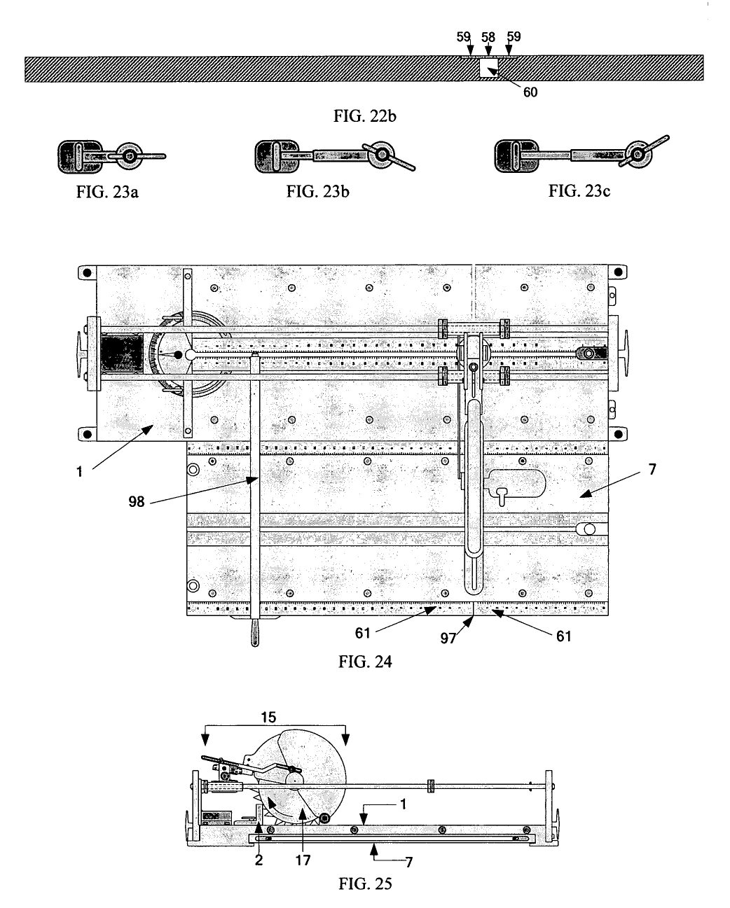

Refer to FIGS. 22-24. The extension platform 7 has a unique “plus grove” (+ grove) 60 to provide the multi-function capabilities. The extension platform 7 is also fitted with a “plus kerf plate” 59 which also has a linear plus grove 58 extending from end-to-end (x-x′) and front-to-back (y-y′). The long linear groves (58 and 60) extending from end-to-end (x-x′) of the platform 1 helps in increasing the linear cutting length of the m Mach 50. This is done by extending the dead-end 14 of the main platform 1 by moving the dead-end bevel mechanism 4 from the main platform 1 to the extension platform 7.

The small linear grove 60 extending from front-to-back (y-y′) of the extension platform 7 helps in perfectly aligning the engine 15 blade 17 within this small linear grove 58 of the plus kerf plate 59 when the m Mach 50 is used in table saw configuration. Like the main platform 1, the extension platform 7 has also series of threaded holes 62 on top of it to fasten the screw clamps (FIG. 23a-c) as needed to firmly hold the workpiece during various cutting operations.

The linear scale 61 marked on either side of the extension platform 7 is used to set the rip fence 98 at a required distance from the reference point 97 during the table saw operation. The linear scale 61 also helps in quick marking and cutting of the material to the required size without using an additional tape measure. The extension platform 7, when fitted on either side of the main platform 1, is also used to provide additional support for larger workpieces.

Ball plungers and detents are used for quick and accurate alignment of the main and extension platforms (1 and 7) during the stowing-in of the extension platform 7 underneath the main platform 1. For this, both ends of the main and extension platforms (1 and 7) have ball plungers and plunger detents respectively. The spring loaded balls will plunge into their respective detents when the extension platform 7 tries to cross the main platform 1 during the stow-in. This will arrest further movement of the extension platform 7 unless sufficient force is applied to move the extension platform 7 from the aligned position.

### Turn-Around (Revolving) Miter Fence

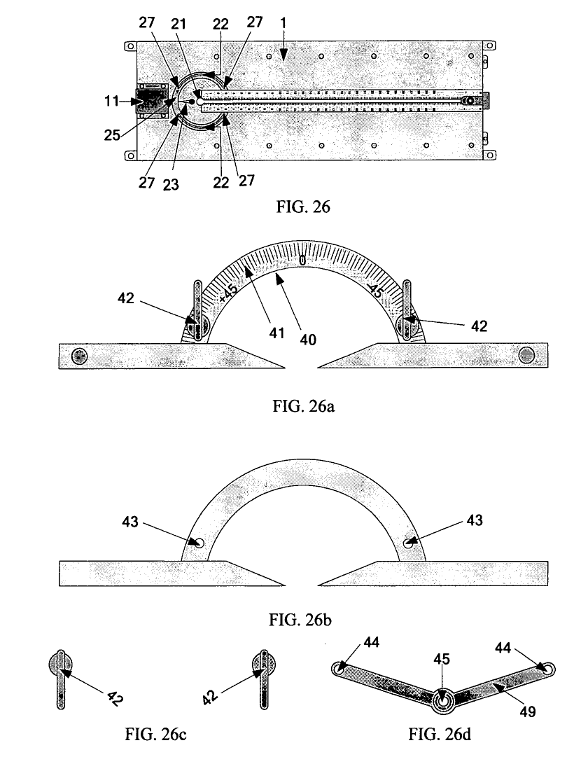

Refer to FIGS. 25-26d. To enable the cutting of the material in required horizontal angles while it is firmly biased against a stable fence, the main platform 1 of m Mach 50 in fitted with a unique turn-around (also called, revolving) miter fence 2 at all times during various cutting operations.

The turn-around miter fence 2 that is used in m Mach 50 is in contrast to the mechanisms that are normally adopted in other miter cutting machines. In other miter machines, the miter fence is stationary and the motor assembly with its circular blade turns around when the turn table is rotated. Also, in other miter machines, the work piece is biased against the fence on both ends of a stable non-rotating platform. However, m Mach 50 uses a different concept all together. The engine 15 in m Mach 50 does not turn around in horizontal angles during miter cutting operations. Note that the engine 15 in m Mach 50 can still be turned around in its own axis in steps of 90° whenever needed for other operation configurations, which will be explained later sections. Since m Mach 50's engine 15 and hence its circular blade 17 move only in linear directions, the miter fence 2 itself will be turned around to compensate for the required horizontal angular adjustments with respect to the linear motion of the engine 15. Hence, the need of the turn table that houses the engine assembly to handle the horizontal angular movement, which is a must in other miter cutting machines, does not arise in case of m Mach 50. This concept of disintegrating the linear engine 15 travel from the turn-around miter fence 2 mechanism results in unbeatable performance of the machine 50 that can cut exceptionally large and wider materials. In addition, this m Mach's 50 linear engine 15 travel concept helps in expanding the liner cutting power of the machine 50 by simply increasing the length of the main platform 1 with little or no change to the engine 15 or miter mechanism assembly.

The miter fence 2 is always connected to a turn-around miter base plate 49 that is aligned with the miter fence 2 from the underneath of the main platform 1. The quick tight fasteners 42 located on the semi-circular ring 40 of the miter fence 2 are used to fasten the mechanical assembly 49 to the miter fence 2 from the underneath of the main platform 1 while the quick tight fasteners 42 passes through fastener hole 43 and the semi-circular slots 22. The revolving miter fence 2 is turned around in its own axis (21 and 45) while it is held by the mechanical assembly 49 within the circular path 25 by loosening the quick tight fasteners 42 located on the semicircular ring 40 of the miter fence 2. The quick tight fasteners 42 are used to fasten the miter fence 2 to the semi-circular slots 22 of the main platform 1 once the angle is set. The miter fence 2 along with the quick tight fasteners 42 located on it can be turned around within the semi-circular slot 22. The end points 27 of the semi-circular slots limit the miter fence turning angle to less than 90°. The central axis 21 of the miter fence 2 for rotation is centered in such a way that the semi-circular ring 40 of the miter fence 2 always stays in the designed circular path 25 at all times irrespective of the miter angle. The miter fence 2 is adjusted and set at the required miter angle with the help a reference pointer 23 located on the main platform 1. The reference pointer 23 identifies the angular movement of the semicircular ring 40 of the miter fence 2 that is marked with the required miter scale 41 for both positive and negative angles. Once the required miter angle is set, the quick tight fasteners 42 are tightened by applying sufficient torque to firmly hold the miter fence 2 at the set angular position.

In order to enable the quick and accurate cutting at commonly used angles, the semi-circular ring 40 of the miter fence 2 has detents at commonly used miter angles. Detents also help in providing extra support to the fence 2 at commonly used angles when the workpiece is biased against the miter fence 2. Provision also exists to override the miter detents whenever needed. The revolving miter fence 2 and its quick tight fasteners 42 can be completely separated and taken out of the main platform 1 whenever needed.

### Bevel Mechanisms

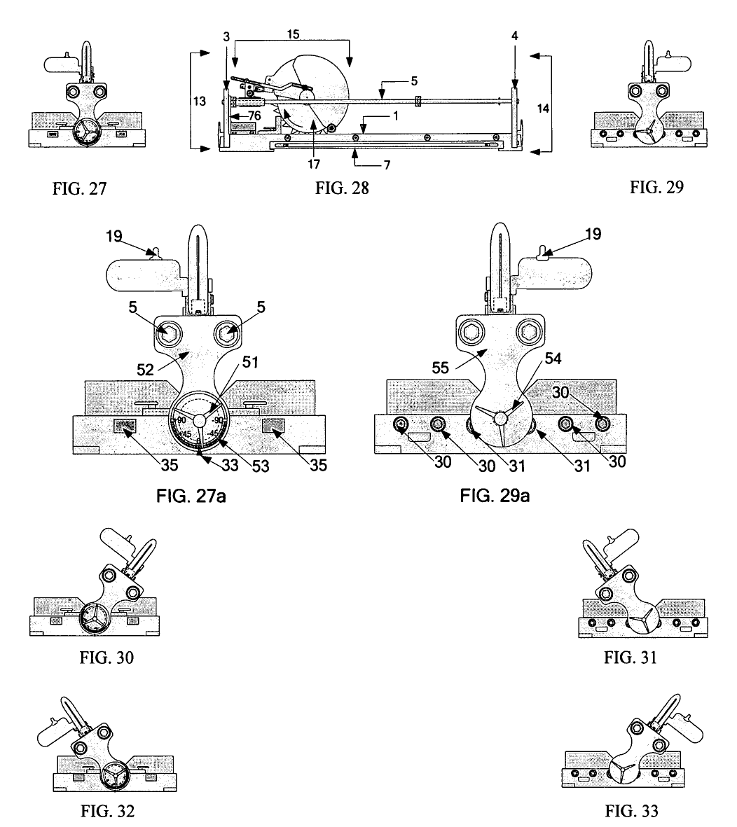

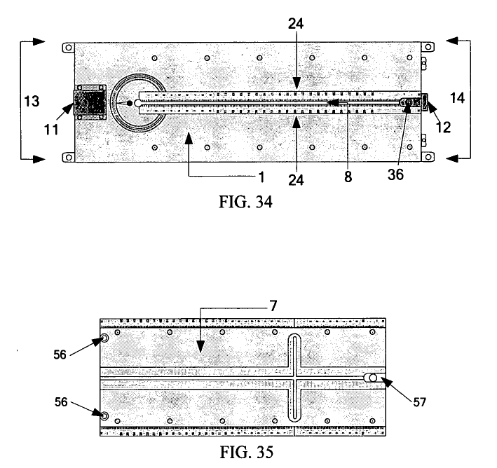

Refer to the FIGS. 27-35. Notice the home-end 13 and dead-end 14 views of m Mach 50 set at different bevel angles in both positive and negative directions. The home-end bevel mechanism 3 assists to set the blade 17 for bevel cutting operations. A bevel scale 53 mounted on the bevel plate 52 of the home-end bevel mechanism 3 will enable the setting of the required bevel cutting angle in both positive and negative sides. The stationary reference pointer 33 located near the bevel scale 53 identifies the angular movement of the bevel plate 52. The reference pointer 33 points to zero on the bevel scale 53 when the bevel plate 52 and hence the cutting blade 17 is in normal, non-beveled position.

In order to set the bevel angle, the triangle handle fasteners (51 and 54) that are located on the bevel plates (52 and 55) are slightly loosened and the bevel plates (52 and 55) are tilted to the required bevel angle by holding the engine handle 19. Since both ends of the guide rails 5 are held by the bevel plates (52 and 55), it causes simultaneous beveling of both the bevel plates (52 and 55). This results in proportional beveling of the engine 15 and the circular blade 17. The central of rotation of the bevel plates (52 and 55), that is in line with the central axis of bevel receptacles (11 and 12), passes through the linear grove 8 of the main platform 1. The rotational axis ensures that the cutting blade 17 always stays within the linear grove 8 of the kerf plate 24 irrespective of the bevel angle. The triangle handle fasteners (51 and 54) are re-tightened once the angle is set by applying sufficient torque. Bevel detents exist in both bevel mechanisms (3 and 4) for the quick and accurate setting of the bevel angles at most commonly used and important positions.

The leveler 35 used with extension support rods 30 to support large workpieces are stowed inside the main platform 1 from the home-end 13 when the leveler 35 is not in use. The levelers 35 are pulled out from the home-end 13 of the main platform 1 when needed.

Though the dead-end bevel mechanism 4 looks similar to the home-end bevel mechanism 3, there are many differences. In contrast to the home-end bevel mechanism 3, the dead-end bevel mechanism 4 can be easily and completely separated out from the guide rails 5 and the dead-end 14 of the main platform 1 whenever needed. This is done by unscrewing the fastener 36 located on the dead-end 14 of the main platform 1 that holds the dead-end bevel mechanism 4. Since both the bevel plates (52 and 55) are tied together with the common guide rails 5, both mechanisms (3 and 4) will follow one another to remain in the defined angular positions and at all times. The option of complete removal of the bevel mechanism 4 attached to the dead-end 14 of the main platform 1 helps in increasing the performance of the m Mach 50 in many ways.

In brief, it helps in extending the length of the machine 50 by transferring the dead-end bevel mechanism 4 from the main platform 1 to the extension platform 7 (place marked 57). A pair of extension guide rails 31 stowed underneath the main platform 1, which can be pulled out from the dead-end 14, is connected to the main guide rails 5 to extend the length of the m Mach 50. The extension guide rails 31 are normally held behind the dead-end bevel plate 55 when not in use. The extension support bases 77 located at the dead-end 14 of the main platform 1 helps in aligning the surface of the extension platform 7 with the main platform 1 and fastening the extension platform 7 with the main platform 1. A pair of fastener holes 56 available on the extension platform 7 can be used to accomplish this.

Also, the ability to operate the m Mach 50 without any compromise with just one bevel mechanism present at home-end 13 can extend the cutting width of the m Mach 50 when the machine 50 is used in table saw configuration. In order to accomplish this, the home-end bevel mechanism 3 has a much larger bevel receptacle 11 compared to the bevel receptacle 12 located at the dead-end 14. This is because, the bevel mechanism 3 at the home-end 13 must be capable of counterbalancing the complete cantilever weight of the engine 15 and the guide rails 5 in the absence of the dead-end bevel mechanism 4. Care must be taken to ensure that the maximum length of the main guide rails 5 is within the safe operation limits of the home-end bevel mechanism 3. However, to reduce the load on the home-end bevel mechanism 3 during the absence of the dead-end bevel mechanism 4, an additional load bearing slider 76 that normally resides at the home-end 13 can be slid and set at any position underneath the guide rails 5. This helps in providing exceptional support to the engine 15 and the guide rails 5 during the absence of the dead-end bevel mechanism 4.

The extension support rods 30 used for supporting large/long workpieces are normally stowed underneath the main platform 1. The extension support rods 30 are pulled out from the dead-end 14 of the main platform 1 when needed for use.

### Main Engine (or Engine)

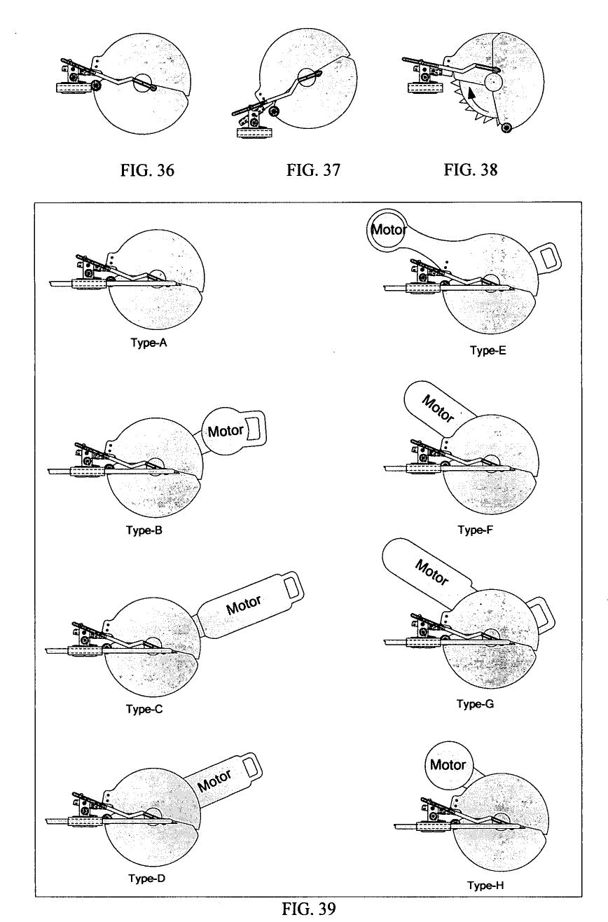

The heart of the m Mach 50 is its main engine 15 (simply called, engine 15). FIGS. 36-38 show the main engine 15 under various conditions. In order to understand the unlimited potential of the m Mach 50, it is necessary to learn about the different type of engines 15 that can be used in m Mach 50 and the unique way of reverse driving the engine 15.

Important information on Engine (15) types and their interchangeability:

Unless otherwise stated, all the explanation and the FIGS. described in this document are for the entire type of engines (Type A-H) shown in FIG. 39 and the variations thereof. For the purpose of explanation, only one type of engine 15 (Type-A) is used throughout this document. It must be noted during all the times that the m Mach 50 is able to accommodate any type of engines (Type A-H) and the variations thereof without problems. Hence, please substitute any other type of engine 15 of your choice whenever needed during the explanation of m Mach 50.

### Reverse Driving

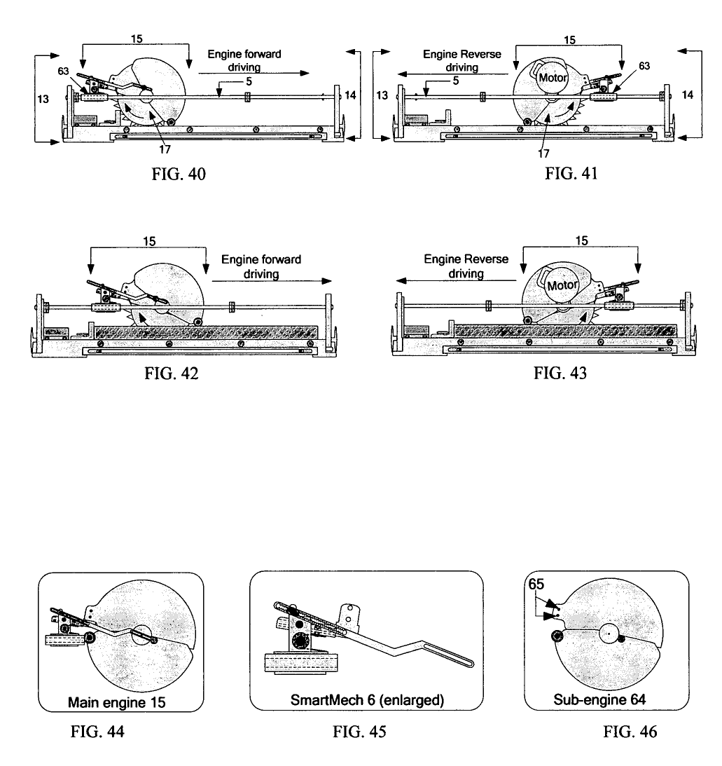

In order to understand the reverse driving, let us focus our attention to FIGS. 40-41. The reverse driving of the engine 15 does not mean rotating the cutting blade 17 in the reverse direction. Also, it does not mean pushing or pulling the engine 15 as we normally do during the cutting of the workpiece. Note that the all type of engines 15 used in m Mach 50 can be manually moved back and forth during all cutting operations (except under table saw operating configuration) irrespective of the forward or reverse driving conditions. The reverse driving in case of m Mach 50 means making the engine 15 to travel in the opposite direction for normal cutting operations after the engine 15 is twisted horizontally and set at 180° from its normal (zero) position. In other words, during reverse driving, the normal home-end 13 becomes dead-end 14 and vice-versa.

Now, carefully observe the engine 15 and its home-end 13 in FIGS. 40-41. The engine 15 shown in FIG. 40 is set to its normal position (0°) to move in the forward direction where as the same engine 15 in FIG. 41 is twisted horizontally and set at 180° to move in reverse direction. This quick twisting of the engine 15 is done without taking the engine 15 out of the guide rails 5. The unique engine 15 twisting mechanism called the TwistMech 63 is used to set the engine 15 to move in forward or reverse direction on the guide rails 5 to cut the workpiece. Later sections will help you understand how the actual twisting of the engine 15 is achieved to operate the m Mach 50 in different configurations. FIGS. 42-43 show the cutting of the material when the engine 15 is set to move in forward and reverse directions.

### Advantages of Reverse Driving

By default, full double bevel cutting on either side is possible for all type of engines irrespective of their motor 18 housing and its orientation with respect to the blade 17.

Start and end point of the cutting can be reversed without realigning the heavy workpiece resulting in very safe operation.

An operator can freely move around the m Mach 50 and adjust himself/herself and the engine 15 driving direction rather than confining to one side of the machine 50.

An operator can avoid the obstruction by the large workpiece during the cutting of the material by choosing the right driving direction.

During the miter and bevel cutting operations, it is easy to have the engine 15 twisted and driven in the required direction rather reorienting and aligning the heavy workpiece.

### Detailed Description of the Main Engine

Now let us turn our discussions to the main engine 15 or simply called, the engine 15. FIG. 44 shows the main engine 15 (type-A, for the sake of explanation) that can be quickly separated out with the help of the quick release pins 65 into two major parts, whenever needed. They are:—

Integrated slider-cum-multifunction mechanism, called the SmartMech (FIG. 45 and identified by 6), and

The sub-engine (FIG. 46 and identified by 64).

### Integrated Slider-Cum-Multifunction Mechanism (SmartMech)

Refer to FIGS. 44-47. The Integrated slider-cum-multifunction mechanism (SmartMech) 6 slides on one or more parallel guide rails 5 while the sub-engine 64 is held by the SmartMech 6. The highly efficient SmartMech 6 greatly enhances the performance of m Mach 50 while drastically reducing the time needed for operation readiness when the m Mach 50 is required to perform in different operating modes.

The SmartMech 6 that is always attached to the sub-engine 64 during all modes of operation (except the circular saw mode) itself consists of six different mechanisms integrated to perform various operations that are explained in details in the following sections. The six different mechanisms that are integrated within SmartMech 6 are:—

Integrated slider that slides on one or more parallel guide rails 5 when the engine 15 is pushed away or pulled towards the personal with the help of the handle 19 located at a convenient place on the engine.

Engine depress and lift-up mechanism that helps in holding the engine 15 at a desired height with the aid of a spring loaded auto retractable pivot mechanism. The engine 15 is manually lifted-up and pushed-down with the help of the handle 19 located at a convenient place on the engine 15.

Engine twisting mechanism with detents at every 90° that helps in twisting the engine 15 in horizontal angles around 360° directions in steps of 90°.

Engine Stretch mechanism by which the engine 15 can be moved forward or backward within the SmartMech 6 to align the cutting blade 17 on the platform during table saw modes or when the blades 17 of different sizes are used.

Engine insert and release mechanism by which the sub-engine 15 alone can be completely taken out of the SmartMech 6 or slipped back in to it with the help of the quick release pins 65, and,

Croc-lever mechanism that helps in setting the initial positioning of the auto-retractable blade guard 16. The croc-lever mechanism also helps in steadily opening or closing of the auto-retractable blade guard 16 as the engine 15 is pushed down or lifted-up during cutting operations.

### Detailed Explanation of SmartMech

### Integrated Slider

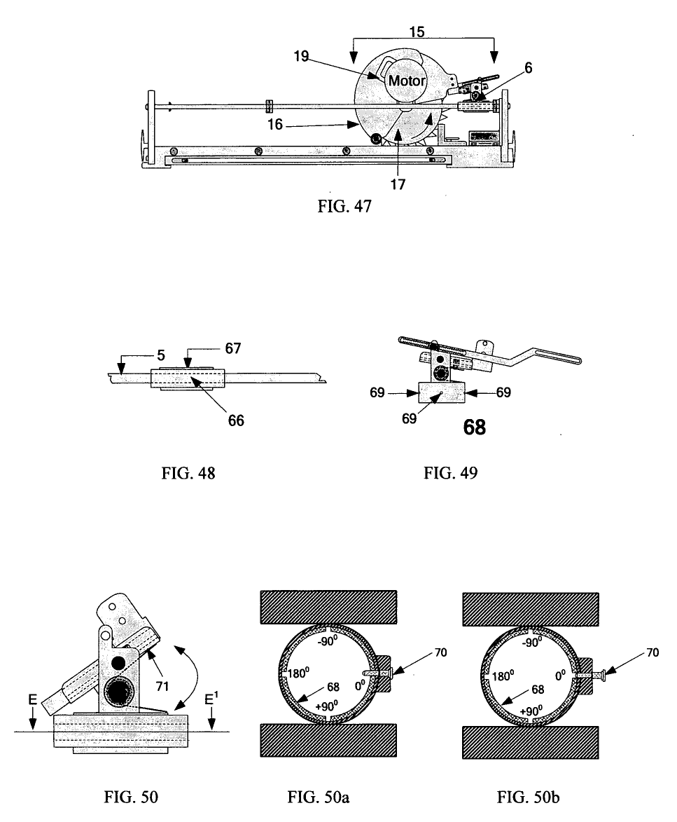

Refer to FIGS. 47-50b. The integrated slider 66 of the SmartMech 6 slides on one or more parallel guide rails 5 while the integrated slider 66 is held by the guide rails 5 at all the times.

The receptacle 67 for housing the top assembly 68 of the SmartMech 6 is also integrated with the integrated slider 66. The receptacle 67 firmly holds the top assembly 68 and hence rest of the engine 15 and helps the integrated slider to move the engine 15. The engine 15 is manually moved on the guide rails 5 with the help of the handle 19, located at a convenient place on the engine 15, while the electric power is supplied to the engine. A ON/OFF power switch located at a convenient place, preferably underneath the handle 19 helps in controlling the power to the engine 15 as needed.

The top assembly 68 of the SmartMech 6 (and hence the rest of the engine 15) can be twisted around 360° horizontal angles in steps of 90°. This is done to set the m Mach 50 in various operation configurations. The TwistMech lock pin 70 that is located in the middle of the integrated slider 66 on one of its sides will help in firmly holding the top assembly 68 within the receptacle 67 in set position. The top assembly 68 can also be completely taken out from or put back into the receptacle 67 whenever needed.

### Engine Depress and Lift-Up Mechanism (DalMech)

Refer to FIGS. 51-54. Engine depress and lift-up mechanism, also called DalMech and identified by 71, helps in manually moving the engine up and down against the workpiece while it is held by the auto-retractable pivot mechanism 78. FIG. 51 shows the engine 15 depressed and locked at a position. This is the condition when the auto-retractable blade guard 16 and the depress mechanism 71 are both locked when the m Mach 50 is not in use. This is also the configuration of m Mach 50 during the transportation. FIG. 52 shows the m Mach 50 with its engine 15 lifted up completely which is the resting condition with the automatic retractable blade guard 16 is kept unlocked. This is also the condition in which the machine 50 is ready for immediate use. The depress mechanism 71 can be kept locked to arrest the engine 15 in this condition if needed for the safety. Also, this is the condition in which the whole engine 15 can be twisted (within its axis) around 360° in steps of 90° to setup the m Mach 50 in different operating configurations, explained in later sections. FIG. 53 shows the position of the circular blade 17 when the engine 15 is held depressed with the option of locking the depress mechanism 71 at this height. Under this mode, the circular blade 17 will rotate and cut the workpiece (FIG. 54) when the power is supplied to the engine 15 with the help of a power switch (located underneath the handle or at a convenient place) while the engine 15 is moved along the linear grove 8 of the kerf-plate 24 of the platform 1. Note that the power switch that turns ON/OFF the power to the engine 15 can not be turned ON when the m Mach 50 is in transportation or resting configuration.

FIGS. 55-58 show the SmartMech 6 with its depress and lift-up mechanism 6 (DalMech 6) set at different heights. The pivot mechanism 78 based auto-retractable DalMech 71 helps in manually lowering the engine 15 or smooth lift-up (by spring retraction while it is slowly released by the personnel) of the engine 15 and hence the cutting blade 17 against the material that is being cut. The DalMech 71 also consists of the engine depress lock 72 for arresting the engine 15 at any desired height, including that which is required for the transportation.

When the engine depress lock 72 is kept unlocked and the auto-retractable blade guard 16 lever is set in normal position and when the engine 15 is steadily pushed down by the handle 19 grip, the automatic retractable safety blade guard 16 that covers the blade 17 steadily opens up to aid the cutting of the material by the blade 17. Similarly, when the engine 15 is steadily lifted-up while the engine depress lock 72 is still kept in unlocked position, the automatic retractable blade guard 16 steadily covers the blade 17.

### Engine Twisting Mechanism (TwistMech)

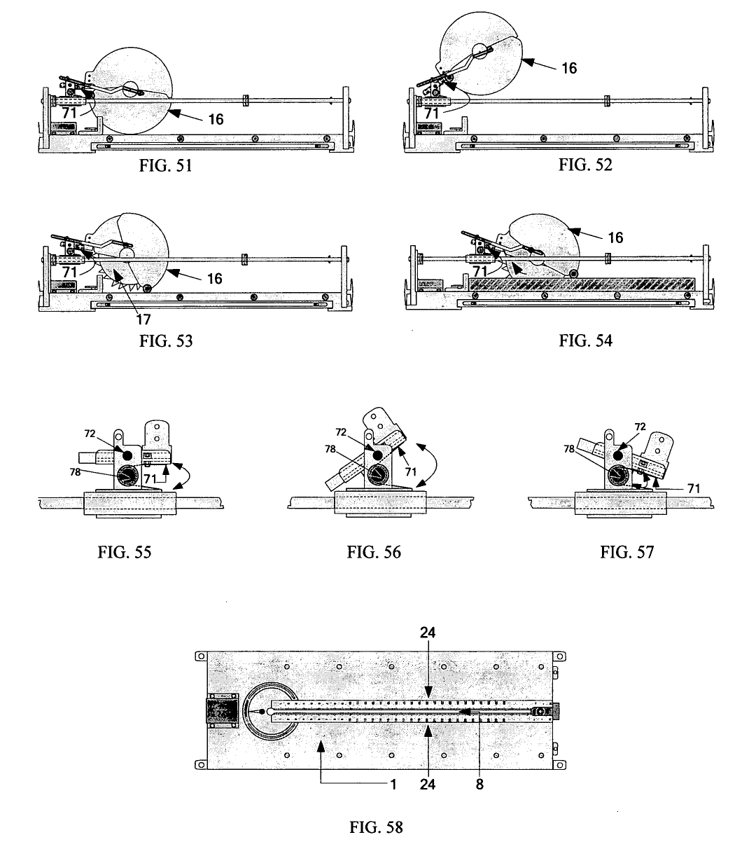

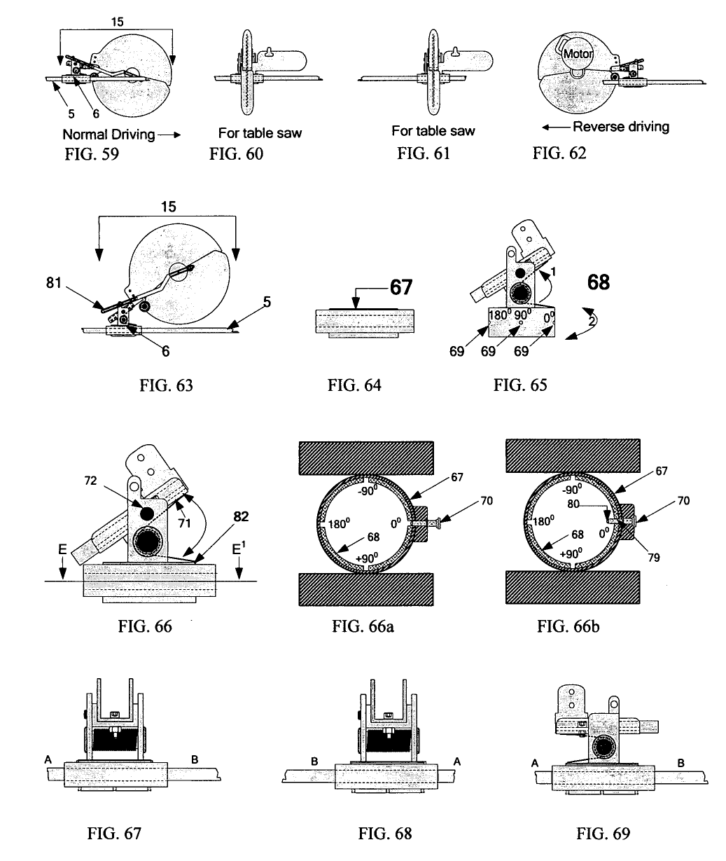

FIGS. 59-62 show the engine 15 twisted in 4 different horizontal angles (0°, +90°, −90°, 180°) while the SmartMech 6 is not disturbed from its initial position on the rails in all the four angles. Also, notice the position of the guide rails 5. With this mechanism, the entire engine 15 can be forward driven along the guide rails 5 when it is set to 0° (home) position or reverse driven when the engine 15 is set to 180° position. As mentioned earlier, please note that the engine 15 can be manually moved back and forth from one end to other irrespective of its driving direction. This bidirectional driving of the engine 15 allows the personnel to easily adjust themselves on either side of the engine 15 to operate it without restrictions. It also helps in cutting large workpieces in either direction without constraining to any one side of the engine 15. Also, the start and end point of the cutting can be reversed at will. Most of all, when the engine 15 is set at +/−90°, the m Mach 50 can be operated as a table saw.

FIGS. 63-66b helps in understanding the engine 15 twisting process. In order to perform the twisting operation, it is necessary to adjust the DalMech 71 (depress and lift-up mechanism) to its highest level so that the engine 15 is lifted-up to its maximum. This helps in angular twisting of the engine 15 without any chance of being obstructed by the guide rails 5 of the m Mach 50.

The SmartMech 6 has an integrated angular twisting mechanism (also called TwistMech 82, by which the whole engine 15 can be horizontally twisted from 0° to 360° in steps of 90° in both clockwise and counter-clockwise directions for setting-up the m Mach 50 to perform various tasks. Quick and accurate setting of the engine 15 in different angles is achieved by the plunging ball 80 of the ball plunger 79 into the plunger detents 69, present within the TwistMech receptacle at 0°, +90°, −90°, 180° positions.

Now, refer to the cross sectional views of SmartMech 6 cut across E-E′ and seen from the top. For clarity, the croc-lever 81 on the SmartMech 6 is not shown in figures during the explanation of the twisting mechanism.

The receptacle 67 of the SmartMech 6 houses a TwistMech lock pin 70 integrated with a ball plunger 79. When the lock pin 70 is pulled-out to its maximum as shown in FIG. 66a, only the spring loaded ball 80 of the ball plunger 79 will be in contact with the outer circular portion of the top assembly. This enables the twisting of the top assembly 68 within the receptacle 67 without being obstructed by the lock-pin 70 while the spring loaded ball 80 is ready to plunge when it comes in contact with the plunger detents 69 of the top assembly 68. The detents 69 on the top assembly 68 located at 0°, −90°, +90° and 180° helps in quick and accurate setting of the engine 15 when any of the detents 69 come in contact with the ready-to-plunge ball 80 when the top assembly 68 is twisted in positive or negative directions. Once the ball 80 plunges into any of the detents 69, the lock pin 70 can be completely pushed-in thus arresting the top assembly 68 in that position. FIGS. 67-69 show the TwistMech 82 set at 3 different angles.

As explained earlier, the top assembly 68 of the SmartMech 6, which is firmly locked by the lock-pin 70 during normal operation can be completely taken out from or put back into the receptacle 67 when the lock pin 70 is kept pulled-out to its maximum, which unlocks the top assembly 68.

### Engine Stretch Mechanism (StretchMech)

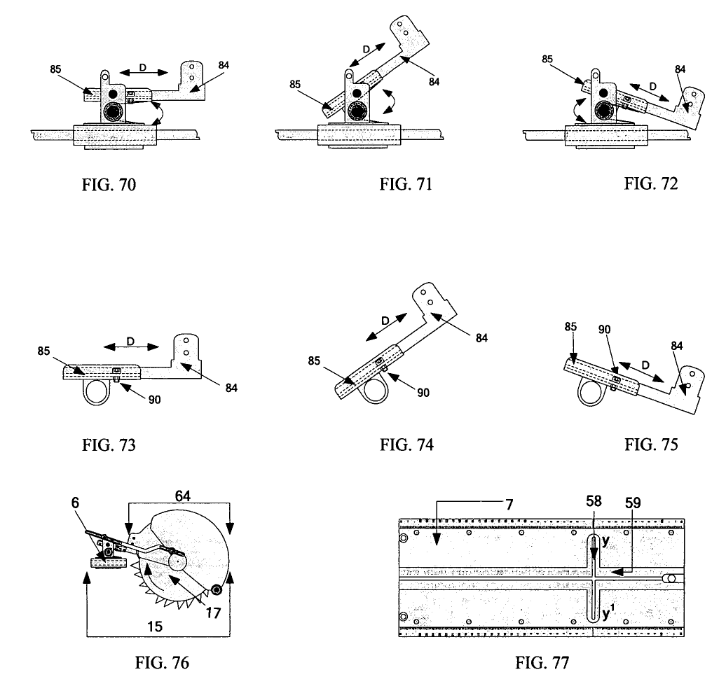

Refer FIGS. 70-77. FIGS. 70-72 show the SmartMech 6 in different stretching conditions irrespective of the set status of other mechanisms within the SmartMech 6. The unique stretch and contract mechanism called “StretchMech”, hereafter identified by 83, is used to increase or reduce the distance between the sub-engine 64 and the SmartMech 6. The stretcher 84 that is confined to travel within the channel 85 from end-to-end helps in setting the distance D between the channel 85 and the stretcher 84. The fastener 90 helps in fastening the channel 85 and the stretcher 84 at the set stretch distance D. This result in adjusting the engine 15 such that the circular blade 17 is positioned exactly within the linear grove 58 of the plus kerf plate 59 (between y-y′) when the m Mach 50 is used in table saw configurations. Additionally, the StretchMech 83 helps in setting the sub-engine 64 to the desired distance from SmartMech 6 when the sub-engine 64 with different blade 17 sizes are used in m Mach 50.

### Engine Insert and Release Mechanism (IRMech)

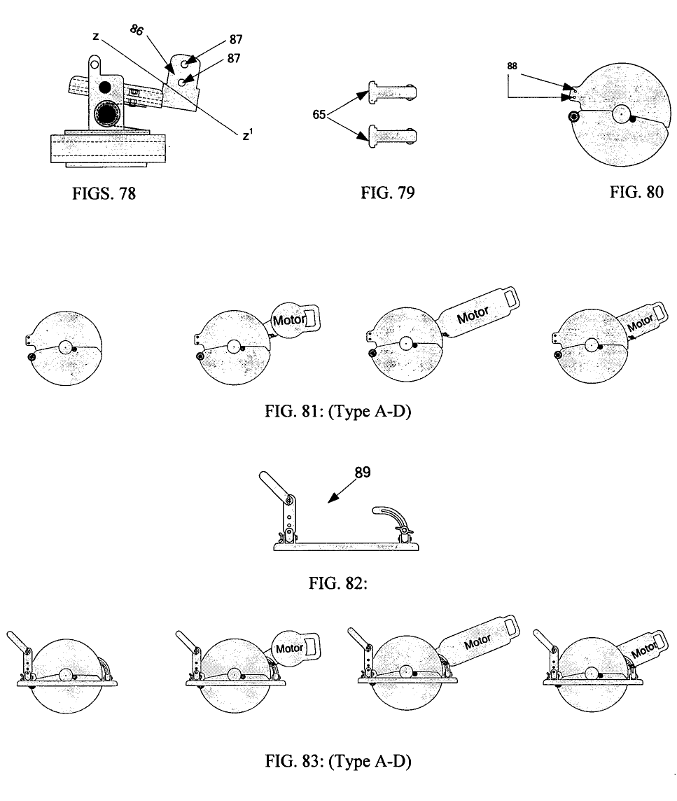

Refer to FIGS. 78-83. The insert and release mechanism, also called IRMech, which is an integral part of the SmartMech 6 is separated by a line z-z′ and identified by 86. The IRMech 86 helps in separating out the sub-engine 64 from or inserting back into the SmartMech 6.

The IR pins 65 are used to accomplish this. During the normal operations, the IR pins 65 are kept pushed-in to lock the sub-engine 64 to the SmartMech 6. When locked, the IR pins 65 pass through pin holes 87 and pin holes 88.

To perform the insert and release operations, the sub-engine 64 is unlocked by pulling-out the IR pins 65 to their maximum. When separated, the sub-engine 64 can be independently transported. Further, the sub-engine 64 alone can be used as a circular saw by snapping-in the “Integrated handle with bevel-cum-cutting depth adjustment” 89 attachment, identified by 89, to the separated sub-engine 64. The attachment 89 is locked to the same pin holes 88 located on the sub-engine 64 using IR pins 65. The operation of sub-engine 64 as a circular saw is explained in detail in the later sections.

The “Integrated handle with bevel-cum-cutting depth adjustment” 89 attachment can be permanently integrated with the sub-engine 64 irrespective of the operation configuration, if needed.

### Croc-Lever Mechanism

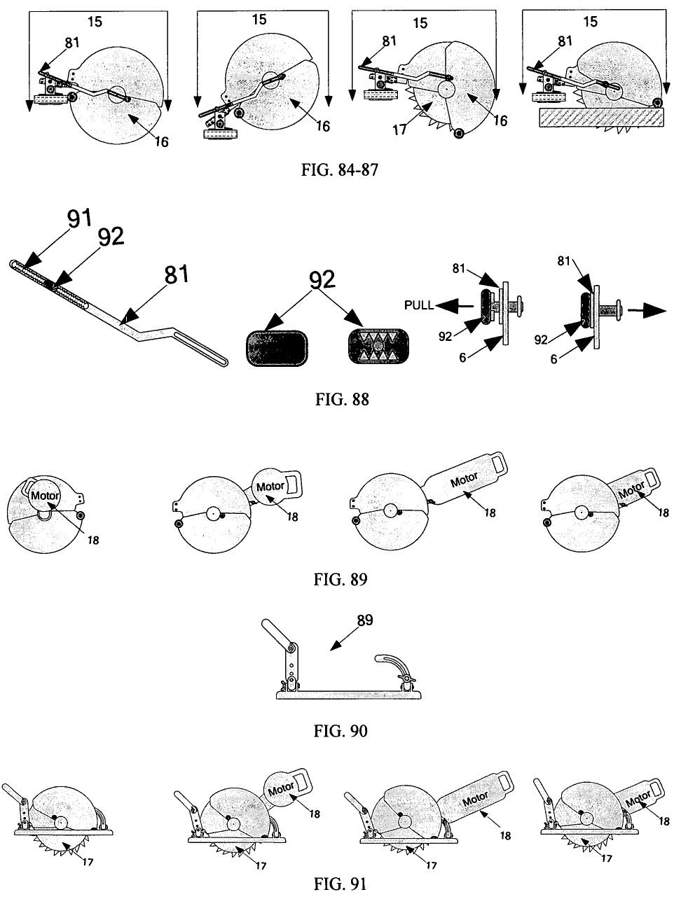

FIGS. 84-87 show the main engine of m Mach 50 set at different heights with their blade guards 16 adjusted independently as needed.

FIG. 88 shows a special kind of lever, for auto retraction of the blade guard 16, called the crocodile-lever 81 or the croc-lever 81. Notice that the croc-lever 81 has a long crocodile slot 91 to accommodate for the croc-pin 92. This mechanism is used for quick setting of the initial length of the croc-lever 81 from the auto-retractable blade guard 16.

Under normal conditions, the croc-lever 81 is firmly held but pivoted by the croc-pin 92 while the croc-lever 81 moves up and down along the engine 15 at all the times when the engine is depressed or lifted-up. In order to adjust the croc-lever's length from the blade guard 16, the croc-pin 92 must be kept pulled-out to its maximum. Under this condition, the croc-lever 81 is moved back or forth and set at desired point. The croc-pin 92 is pushed-in back to its original place, to firmly hold the croc-lever 81 pivoted, once adjusted. Once the croc-pin 92 is pushed-in, the lever can only twist-around the pivoted croc-pin's central axis. The croc-lever 81 cannot be moved back or forth along its length when the croc-pin 92 is pushed-in.

During the transportation (as shown in FIG. 84) of the m Mach 50, the croc-lever 81 is pulled towards the blade guard 16 and set to close the blade guard 16 even when the engine 15 is completely depressed. With this, the blade guard 16 covers the cutting blade 17 completely and the machine 50 can be safely transported. The croc-lever 81 is also used to set the length of the lever from the blade guard 16 in accordance with the distance set using the StretchMech 83 (FIG. 73-75). The croc-lever 81 is also used to adjust the blade guard 16 to set the initial retraction when the cutting blades 17 of different sizes are used. Further, the croc-lever 81 also helps in setting up the required initial retraction and hence the blade guard 16 height against the workpiece for the safe operation when the m Mach 50 is used in the table saw configuration.

### Sub Engine

Refer to the FIGS. 89-91 that show A, B, C and D-type sub-engines 64. As mentioned earlier, the sub-engine 64 is identified by the absence of SmartMech 6 from the main engine 15. The sub-engine 64 consists of the motor 18 assembly and the cutting blade 17 with the required safety features. The sub-engine 64 can be easily and quickly set up to work as a circular saw as shown in FIG. 91 when it is fitted with the “Integrated handle with bevel-cum-cutting depth adjustment” 89 attachment shown in FIG. 90, provided that the maximum size of the cutting blade 17 meets the safe operating requirements. This simple-yet-powerful “Integrated handle with bevel-cum-cutting depth adjustment” 89 attachment can be snapped-in only when needed or can be permanently fixed on to the sub-engine 64 at all times, even during the operation of m Mach 50 in other configurations. Later sections will discuss in detail on effectively and independently using m Mach's 50 sub-engine 64 in different modes as a circular saw.

### Miscellaneous

### The Stationary Guide Rails

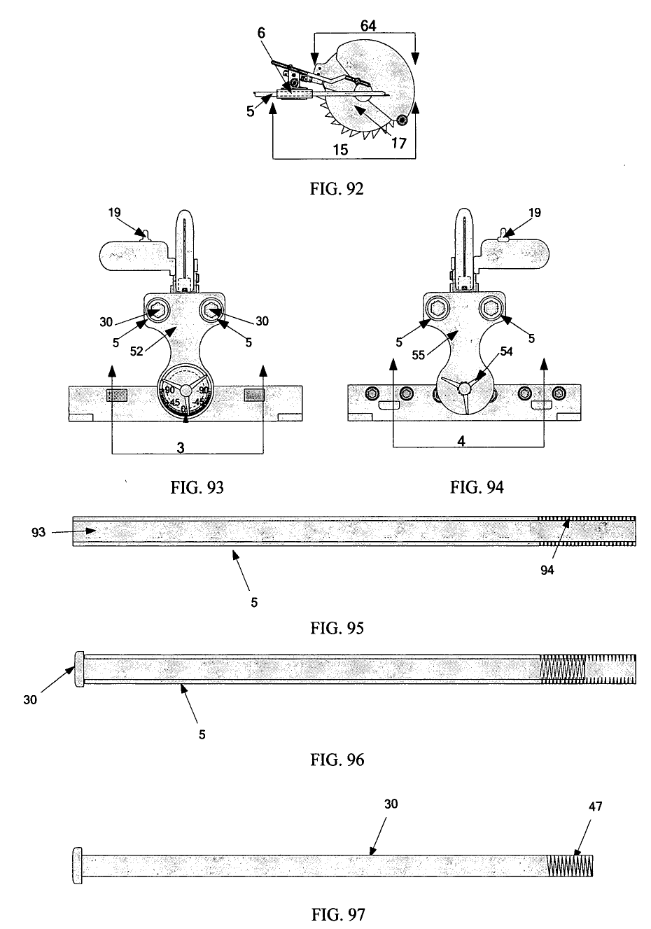

FIG. 92 shows the SmartMech 6 on guide rail(s) 5. The m Mach 50 is fitted with one or more guide rails 5. The guide rails 5 aid in sliding of the SmartMech 6 when the engine 15 connected to it is moved back and forth along the rails.

Also, the guide rails are connected to the bevel plates (52, 55) of the home-end and dead-end bevel mechanisms (3, 4). Hence, the guide rails 5 help in beveling the engine 15 and its cutting blade 17 to the desired bevel angle with the help of the handle 19 connected at a convenient place on the engine 15.

Additionally, the guide rails 5 are also used as storage compartments for storing the extension support rod 30 that are used for supporting large workpieces during all cutting operations. FIG. 96 shows the extension support rod 30 slid-inside the hollow tube 93 of the guide rail 5 from the home-end bevel mechanism 3 and stowed inside the hollow tube 93 of the guide rail 5. The thread end 47 of the end the extension support rod 30 is used to fasten the extension support rod 30 to the thread 94 inside the hollow tube 93 of the guide rail 5. The extension support rod 30 is taken out of the hollow tube 93 when needed. FIG. 97 shows the extension support rod 30 separated from the hollow tube 93 of the guide rail 5.

### Engine Stoppers

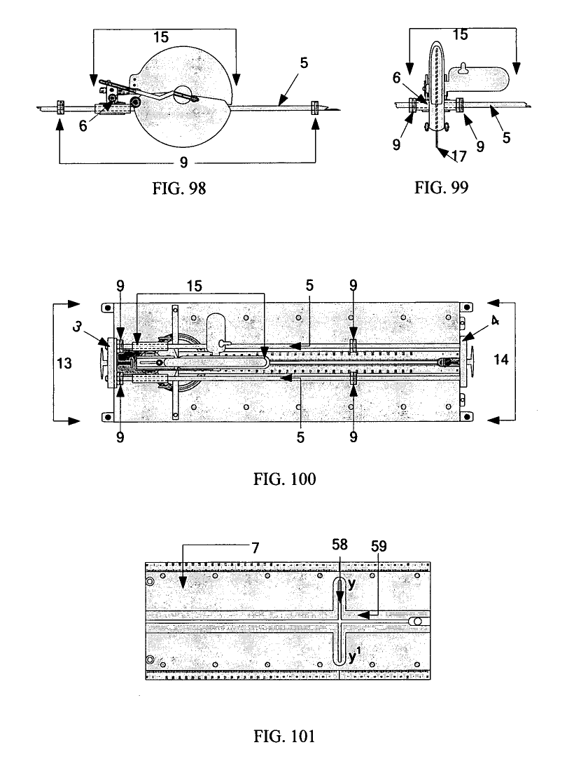

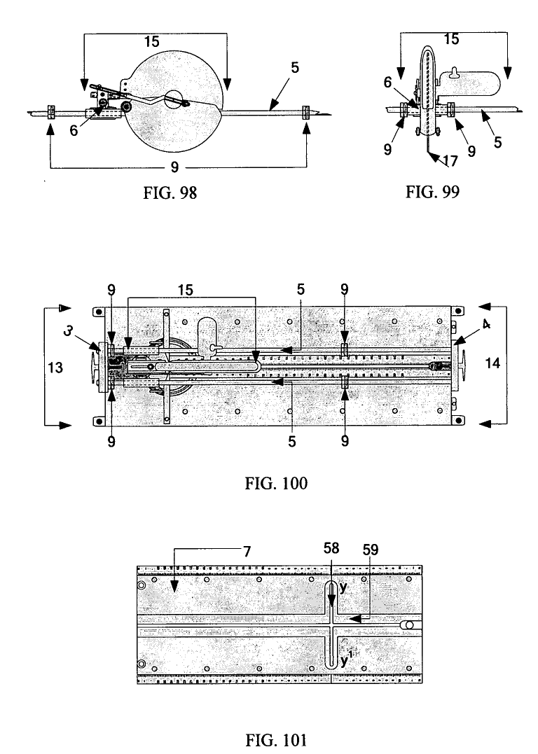

Refer to FIGS. 98-101. Engine stoppers 9 play a significant role in stopping the engine 15 at desired points while cutting the workpiece. Though the engine stoppers 9 are optional, it is highly recommended at all times to arrest the engine 15 at required points for safe and precise cutting operations and they must be always used in the table-saw configuration. At least two engine stoppers 9 normally set at desired position on both sides of the SmartMech 6 on one or more guide rails 5 are required for the safe operation of the m Mach 50.

FIGS. 98-99 show one of the possible ways of stopping the engine 15 at desired positions. This helps in accurately cutting the material to a predefined length by using the engine stoppers 9 as reference points. There are at least two engine stoppers 9 needed on at least one of the parallel guide rails 5. During forward driving operation, home-end 13 engine stoppers 9 are normally kept at home-end 13 unless otherwise needed to position it at different location. Dead-end 14 engine stoppers 9 can be moved and positioned anywhere on the guide rails 5 to serve as the reference for stopping the engine 15 from going beyond the desired point. It is vice-versa for reverse driving operation. The engine stopper 9 also helps from accidentally pulling the engine 15 completely out of the guide rails 5 when the engine 15 is at the dead-end 14 in the absence of the dead-end bevel mechanism 4.

During the operation of the m Mach 50 in table saw mode, both the stoppers 9 must be positioned as shown in FIG. 99 after the engine 15 is set in a particular position on the guide rails 5 while the cutting blade 17 of the engine 15 is within the linear grove 58 (along y-y′) of the kerf plate 59 (FIG. 101) meant for table saw operations. This ensures that the engine 15 is firmly held in one position without creating any safety risk during the operation of m Mach 50 in table saw configuration. All the unused engine stoppers 9 are normally kept near the home-end 13 or dead-end 14 of the machine 50.

### Engine Decelerator

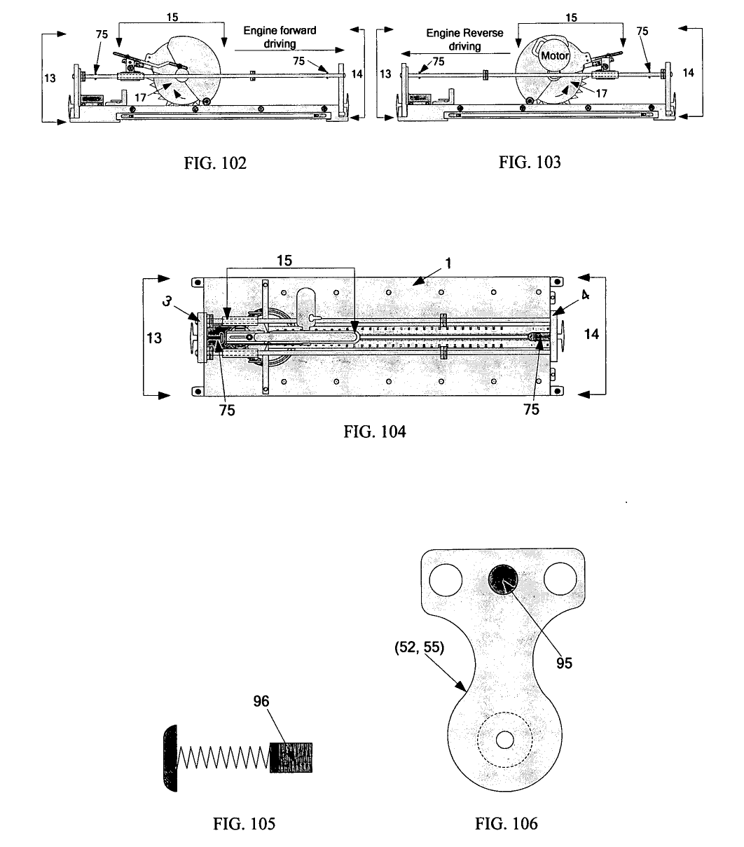

Refer to the FIG. 102-106 that show the m Mach 50 fitted with decelerators 75 at both the ends. The engine 15 in m Mach 50 has to operate in both forward and reverse driving modes. In order to ensure that the engine 15 utilizes the full length of the platform 1, the engine 15 is moved until almost it touches the inner wall of the bevel plates (52, 55) of the bevel mechanisms (3, 4). However, to slow down the engine 15 when the engine 15 reaches either end (13, 14), the m Mach 50 is fitted with at-least one engine decelerator 75 at the dead-end 14.

Normally, the inner side wall of both the bevel plates (52, 55) is fitted with the decelerator 75. The threaded end 96 of the decelerator 75 is fastened to the threaded hole 95 of the bevel plates (52, 55). With this, the engine 15 decelerates when the blade guard 16 of the engine 15 comes against the decelerator 75 when the engine 15 is moved manually toward either ends during cutting operations. The decelerator 75 can be made up of a compression type spring, rubber, hydraulic or pneumatic type.

### Rip Fence

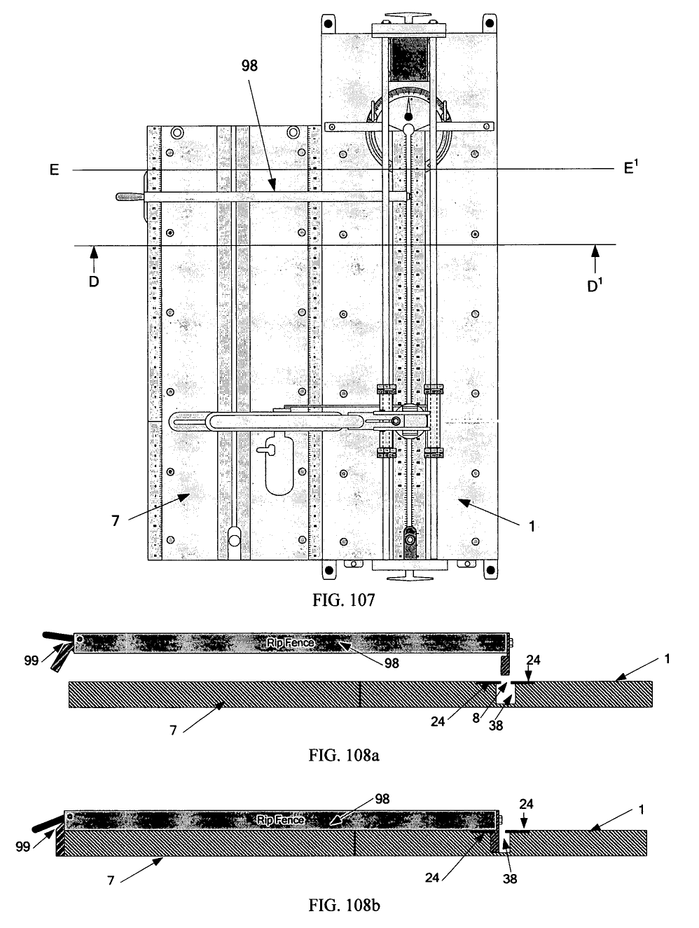

Refer to FIGS. 107-108b. In order to effectively use m Mach 50 in table saw configuration, m Mach 50 employs a very special type of rip fence 98. Unlike other fences, one end of the rip fence 98 in m Mach 50 is held by the side wall of the linear grove 38 that is located underneath the kerf plate 24 of the main platform 1. Other end of the rip fence 98 is clamped to the extension platform 7 by the handle clamp 99 located on the rip fence 98. The rip fence 98 is slid-inside or taken-out from the linear grove 38 of the platform 1 while the handle clamp 99 is lifted-up as shown in the FIG. 108a. Once the rip fence 98 is completely slid inside the linear grove 38, the handle clamp 99 is pressed down to lock the rip fence 98 to the platforms (1, 7) as shown in the FIG. 108b. Thus, the rip fence 98 is effectively held by both the platforms (1, 7).

### Engine Blade Aligner

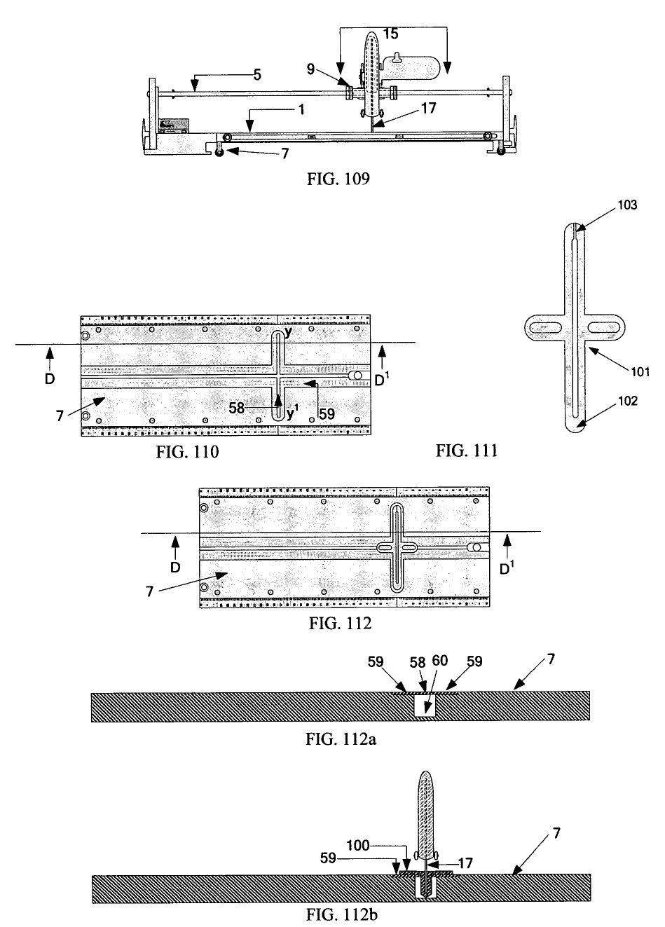

Refer to the FIGS. 109-112b. In order to ensure that the blade 17 is aligned quickly and accurately during the configuration of m Mach 50 to work as a table saw, a special kind of blade aligner 101 is used. FIG. 111 shows the blade 17 aligner. The blade aligner 101 is placed along y-y′ on the linear grove 58 of the kerf plate 59 of the extension platform 7 meant for table saw circular blade 17. The engine 15 is moved on the guide rails 5 and the circular blade 17 is lowered until it is fully inserted into the blade aligner grove 100. This ensures the alignment of the blade 17 exactly in the middle of the linear grove 58 of the kerf plate 59, without physically touching the inner walls of the kerf plate 59. Once the alignment of the blade 17 is made, the engine is depressed and the engine stoppers 9 are tightened to arrest the engine 15 from wobbling. The blade aligner 101 is slightly lifted and pulled out by holding the non-slit end 102 of the blade aligner 101. The flexible slit-end 103 of the blade aligner 101 ensures no obstruction by the engine blade 17 when the aligner 101 is pulled out after alignment.

### The Slider Support for Guide Rails

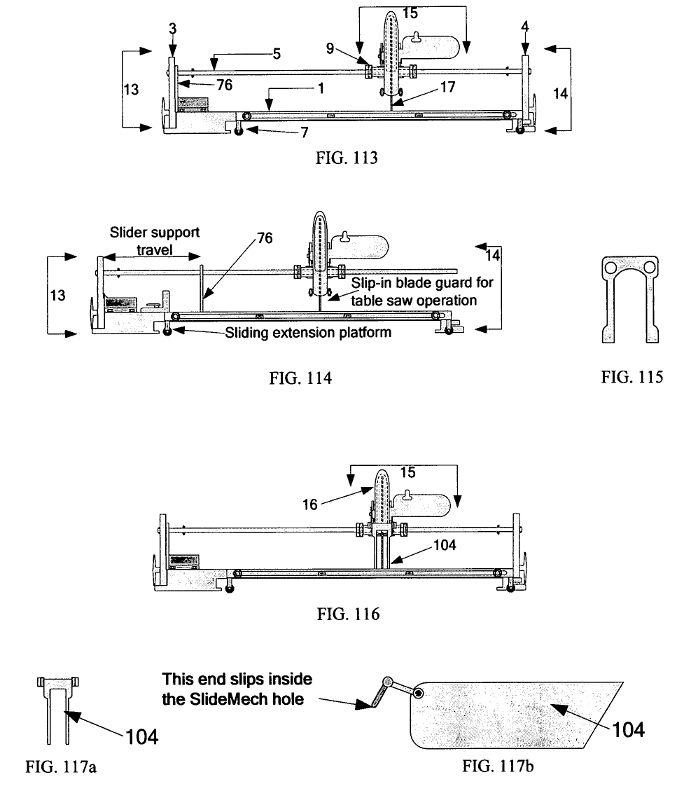

Refer to FIGS. 113-115. Increase in the performance of the m Mach 50 can be achieved in special cases with the absence of the dead-end bevel mechanism 4. One such case is to cut exceptionally larger workpieces when the m Mach 50 is used in the table saw configuration with the dead-end 14 bevel assembly absent as shown in FIG. 114. Though it is not mandatory, such provision can help in many ways. In order to achieve this, the home-end bevel mechanism 3 must be designed to take care of complete counterbalance weight of the engine 15 and the guide rails 5 and their related assembly. This ensures that the m Mach 50 works as usual irrespective of the presence or absence of the dead-end bevel mechanism 4. To provide further stability and exceptional load support under this configuration, the m Mach 50 is equipped with an additional slider support 76 that can be slid-out from its home position and set at the required place underneath the guide rails 5. FIG. 115 shows the front elevation view of the slider support 76. The slider support can be easily slid back to its home position when not in use as shown in the FIG. 113.

### Table Saw Blade Guard (Optional)

The auto-retractable blade guard 16 in m Mach 50 is designed to work in all operation configurations including the table saw. The auto-retractable blade guard 16 can be set to the required initial retracted position to further compensate this. Since the blade guard 16 does not come head-on to the direction of the workpiece during the table saw operating modes, the correct contour must be provided to the blade guard 16 to accommodate for this.

However, the m Mach 50 also accommodates for an additional table saw blade guard 104 like the one shown in 117a-b that can be used during table-saw operating modes. This additional table saw blade guard 104 can be snapped-in only if needed during the table saw operation. The regular auto retractable blade guard 16 can be overridden by setting the blade guard 16 in a fully lifted position. Alternatively, a blade-guard that is more suitable for the required table-saw environment can be integrated within the regular blade guard's (16) design according to the needs.

### Integrated Laser Straight Line Generator

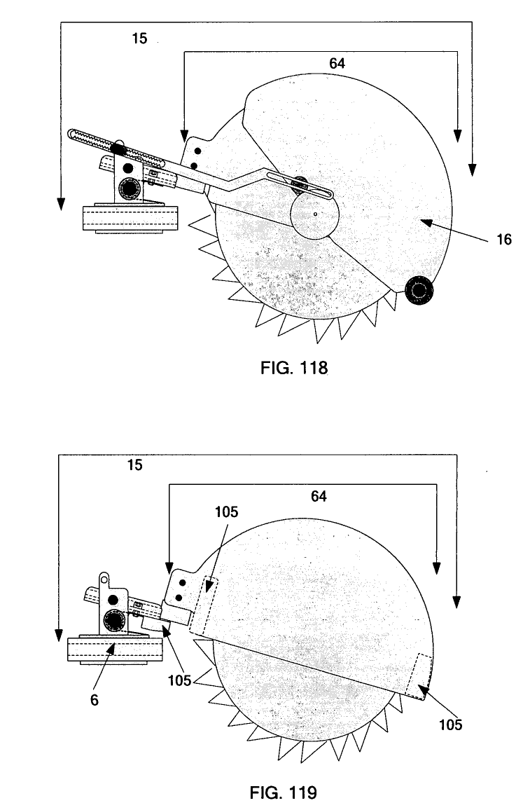

Refer to FIGS. 118-119. FIG. 119 shows the main engine 15 of m Mach 50 with its blade guard 16 completely taken out from the main engine 15 for explanation of Laser equipment 105. The main engine 15 of the m Mach 50 is always fitted with one or more Laser equipments 105 for the generation of laser lines before and during all cutting operations in all configurations. The Laser equipment 105 can be either fitted onto the sub-engine 64 or underneath the SmartMech 6 or in any desired location(s). The Laser equipment 105 must generate an accurate, long and sharp laser straight line on the workpiece covering the complete desired cutting length to use as a reference before and during all cutting operations.

### Dust Collection System

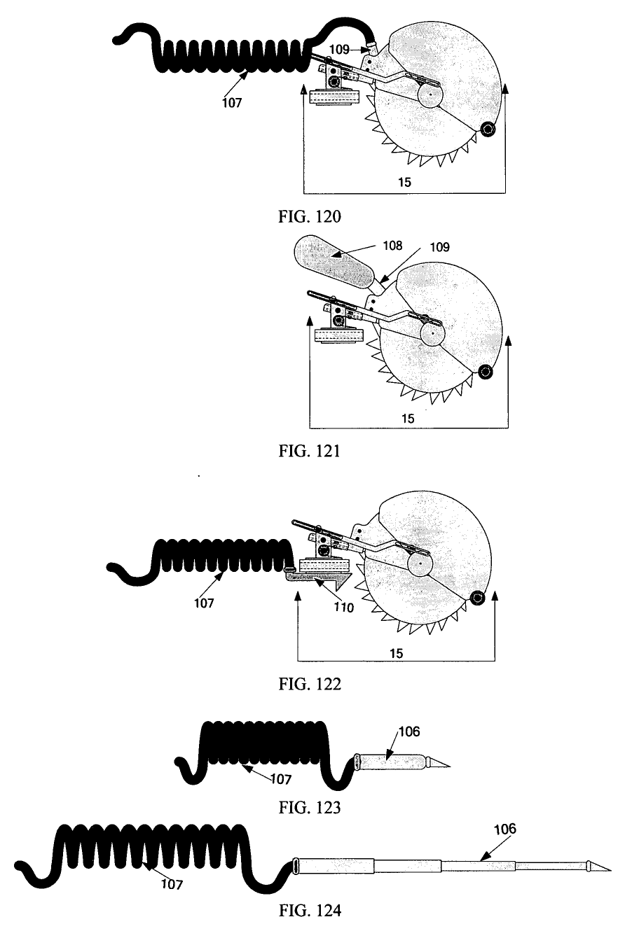

Refer to FIGS. 120-124. The main engine 15 assembly of m Mach 50 can have different type of dust collection systems. All m Mach's 50 will have dust collection tube 109, 110 (rigid, semi-rigid or flexible type) located at a convenient place for the efficient dust collection during all cutting operations.

An auto-stretchable and retractable telescopic tube 106, a flexible hose 107 or combination of one or more of these can also be used to serve dust collection. A flexible hose 107 is connected to the centralized dust collection system by coupling additional hose(s) 107.

For portability, the m Mach 50 can have a local dust collection bag 108 or a system that can be snapped onto the rigid tube 109 located at the rear end of the engine 15.

### Operation Configurations

Before we proceed with the actual operation of the m Mach 50 in different modes under each configuration, let us first learn about the different ways of configuring the m Mach 50.

As can be seen in the following section, the m Mach 50 can be configured to work as a straight or through cutter, a miter cutter, a cross cutter, a chop saw, a table saw and a circular saw. As mentioned earlier the bevel cutting of material in both positive and negative angles and engine reverse driving is possible in all operating modes (expect in table saw modes) explained below.

### Straight or Through Cutter

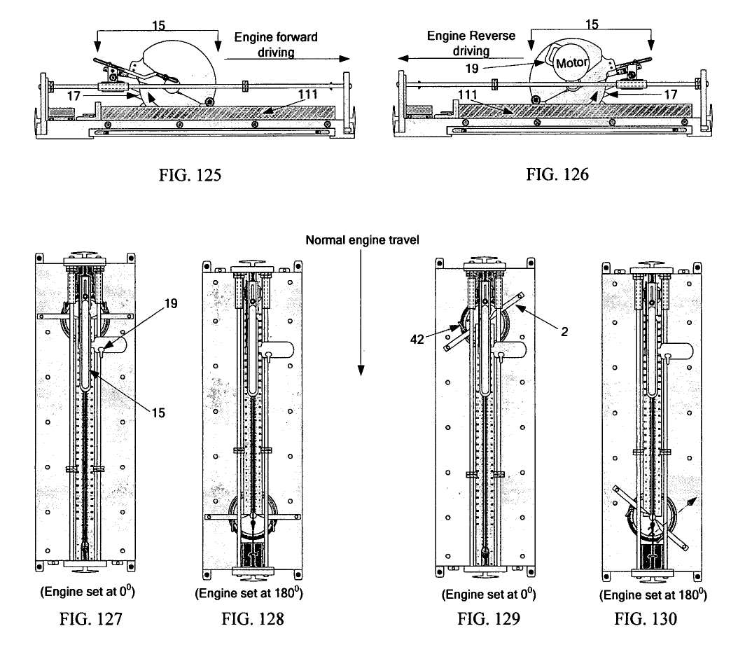

FIGS. 125-1128 show one way of setting the m Mach 50 to work as a straight or through cutter. Under this configuration, the machine 50 can be used in all modes that involve straight cut, cross cut or side creation operations. The engine 15 and hence the rotating cutting blade 17 is moved against the workpiece with the help of the handle 19 connected to it while the electric power is supplied to the engine 15.

### Compound Miter or Cross Cutter

FIGS. 129-130 show the operation of m Mach 50 as a compound miter saw. The revolving miter fence 2 can be set to positive or negative angles with reference to the cutting blade's 17 travel axis in finer steps. As explained in earlier sections, miter detents at important angles allow for the quick setting of the miter fence 2. The miter fence 2 is fastened at the set miter angle with the help of the quick tight fasteners 42 located on the of the miter fence 2.

### Table Saw

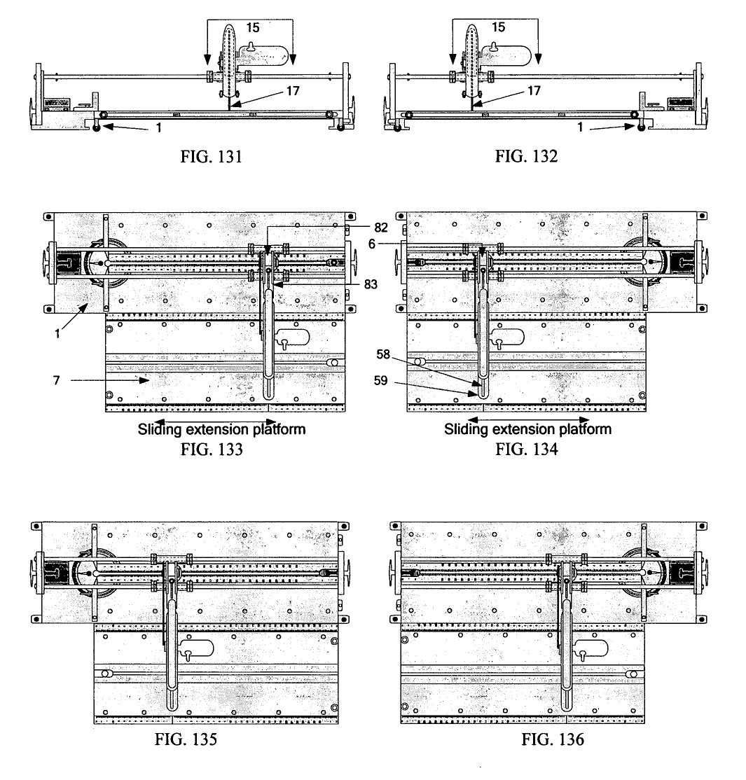

FIGS. 131-136 show the m Mach 50 configured to work as table saw. The advantage of having SmartMech 6 makes it possible to use m Mach 50 as a table saw. In order to have the required table space to use the m Mach 50 in table saw configuration, the multipurpose, sliding extension platform 7 that comes with the m Mach 50 is used in parallel with the main platform 1. Alternatively, the extension platform 7 can be integrated with the main platform's design, if needed. The engine stoppers 9 are used to arrest the engine 15 on the guide rails 5 during the table saw operations. The TwistMech 82 is set at +/−90° and the StretchMech 83 is adjusted to set the circular blade 17 in the required position within the linear grove 58 (along y-y′) of the table saw kerf plate 59 without making physical contact with it. The blade aligner 101 is used for quick and accurate setting of the blade 17 within the linear grove 58 of the kerf plate 59. The blade aligner 101 is slightly lifted and pulled out by holding the non-slit end 102 of the blade aligner 101. The flexible slit-end 103 of the blade aligner 101 ensures no obstruction by the engine blade 17 when the aligner 101 is pulled out after alignment.

### Circular Saw

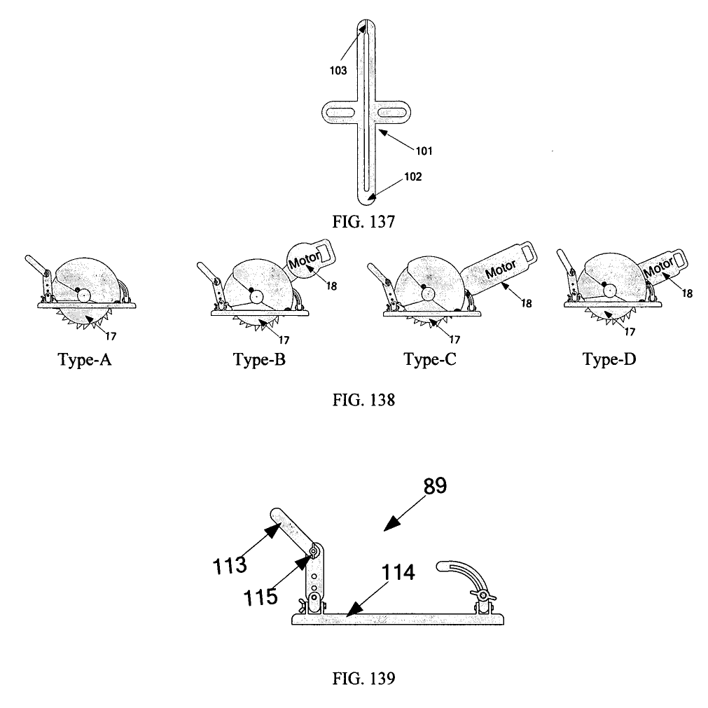

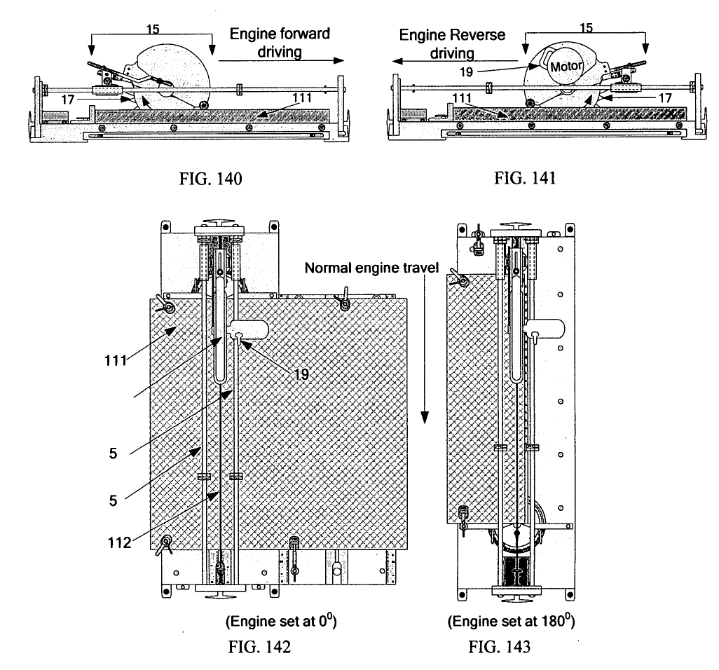

FIGS. 138-139 show the sub-engine 64 of m Mach 50 configured as circular saw. For the safe operation of the sub-engine 64, the “integrated handle with bevel-cum-cutting depth adjustment” 89 attachment can be permanently fastened to the sub-engine 64 in all configurations or snapped-in only when the sub-engine 64 is used in circular saw configuration. Also, note that the handle 113 of the “integrated handle with bevel-cum-cutting depth adjustment” 89 attachment can be easily adjusted to a comfortable angle with the help of the butterfly nut 115. The bevel angle and the height of the cutting blade 17 can also be adjusted by using bevel plate 114 to enable all cutting modes that are expected from a circular saw.

### Using m Mach in Different Configurations

Following sections will illustrate the actual operation of the m Mach 50 in different modes under each of the configurations explained in earlier section. The machine 50 is designed to cut virtually all types of materials such as wood, ferrous and non-ferrous metals, concrete, granite, tiles, plastic and other natural and artificial materials where a circular cutting blade can be used. In all the operating configurations, the laser line can be turned on before and during all cutting operations to adjust and cut the material according to the requirement.

### Straight Cutter

FIGS. 142-143 show few ways of operating the m Mach 50 as a straight cutter, through cutter or a ripper machine. The m Mach 50 engine 15 that manually slides on one or more parallel guide rail(s) 5 is used for straight cut of all materials. The material that needs to be through cut or sliced is placed on the platform 1.

The reference cut line on which the circular blade 17 moves on the workpiece 111 can be seen by the straight laser line 112 generated by the laser fitted underneath the engine 15 or by lowering the engine 15 blade 17 until it just touches the workpiece and moving to either ends on the workpiece before the actual cut is made. The laser line 112 helps the personnel to adjust material according to the desired cut line on which the circular blade 17 is required to travel during the cutting. The cutting of the workpiece 111 is made by manually moving the m Mach 50 from home-end 13 to the dead-end 14 (in case of forward driving) or vice-versa (for reverse driving) while the electric power is supplied to the engine 15 with the help of the power switch located near the handle 19 or at a convenient place.

### Straight-Side Creator (Also Called a Side Creator or Straight-Side Generator)

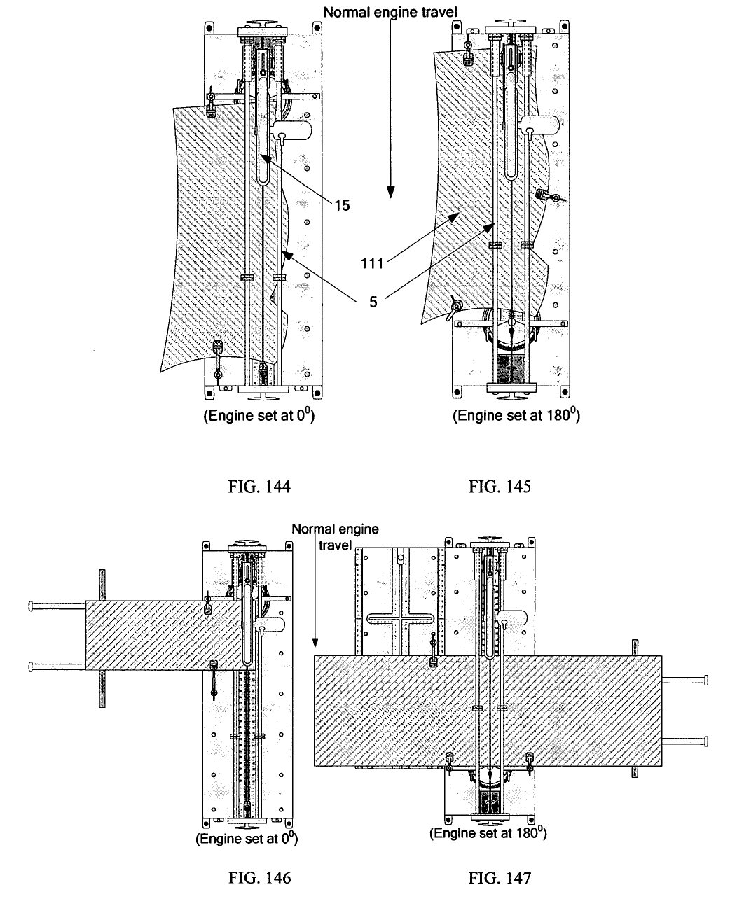

FIG. 144-145 show the operation of m Mach 50 creating straight edge on a workpiece 111 that has uneven edges on all sides. The main advantage of m Mach 50 is that the engine 15 travels on a perfect straight line at all times guided by one or more guide rails 5. Hence, the material to be cut need not have a perfect straight side on at least one of its sides, which is a normally needed for biasing against a stable fence to perform various cutting operations on a material using other type of machines. Since the material that is to be cut is held stationary while the blade 17 travels on the material on a perfect straight cutting path, a perfect straight cut can be achieved when m Mach 50 is used to cut the materials.

### Cross Cutter

FIGS. 146-147 show the m Mach 50 set in regular cross cut position. Though the operation of the m Mach 50 in cross cut mode may appear similar to a regular miter saw that also cross cuts a material, there is a large difference in the way m Mach 50 cross cuts the material. First, the m Mach 50 can cut the materials of much wide lengths where a regular miter machine fails. Second, the m Mach 50 can work in both forward and reverse directions as compared to the regular miter that can only work in forward direction.

### Fixed Rails Compound Miter

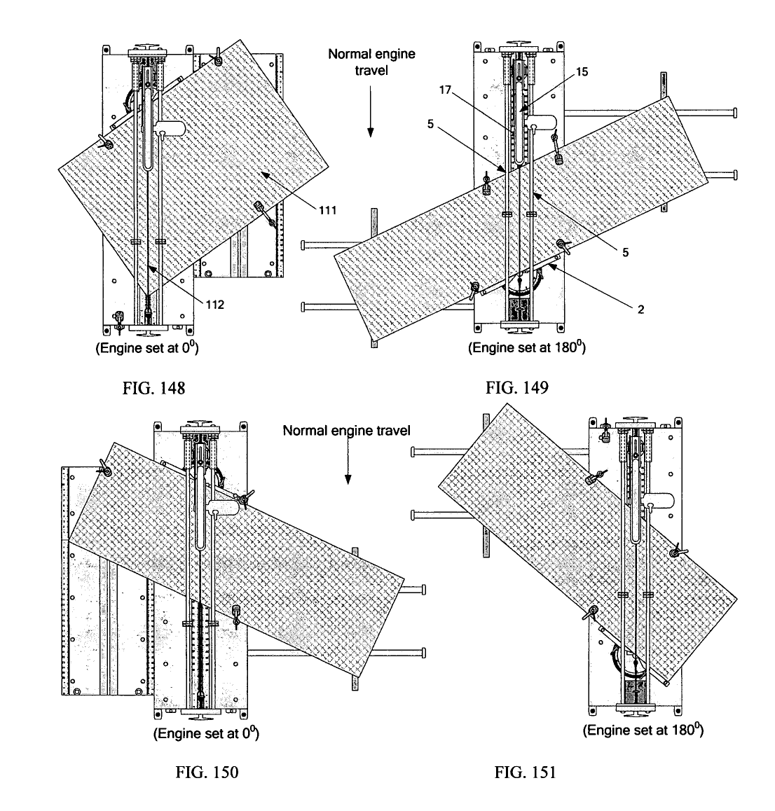

FIGS. 148-151 show the Fixed Rails Compound Miter, hereafter called, FR Miter under various cutting modes. The machine 50 acts as a compound miter saw whose engine slides on fixed guide rails 5. The workpiece 111 to be cut is kept biased against the revolving miter fence 2. The machine 50 is moved against the material 111 while the circular blade 17 that is connected to the motor 18 rotates when it is energized. The uniqueness of this FR Miter as compared to other miter cutting machines 50 is, this machine 50 uses one or more fixed guide rails 5 while only the engine 15 moves on these guide rails 5. Hence, there is no limitation on the desired length of the guide rail(s) 5. With this technique, the material of unlimited size can be cut using this fixed guide rails 5 based miter saw. In contrast, all other miter saws generally use sliding rails as a standard method where the engine is firmly fastened to the sliding rails. Since both the engine and the rails slide together in other miter saws, the maximum travel length of the blade 17 is limited that eventually limits the maximum cutting length in other miter saws.

### Bevel Cutting

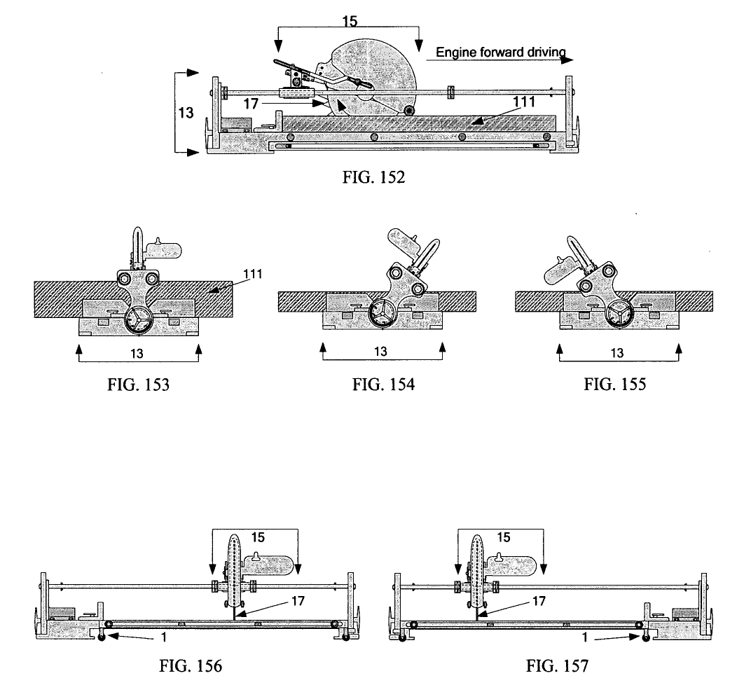

FIGS. 153-155 show the side elevation view of the m Mach 50 (FIG. 152) seen from the home-end 13 during normal and bevel cutting of workpiece 111 at different angles. All type of engines 15 can work in double bevel operation. In some cases, type-A engine 15 may need both forward and reverse driving, depending on the position of motor assembly, to achieve full beveling on either side. As mentioned earlier, bevel detents at most commonly used angles help in quick setting of the cutting blade 17 at the required bevel angles.

### Table Saw

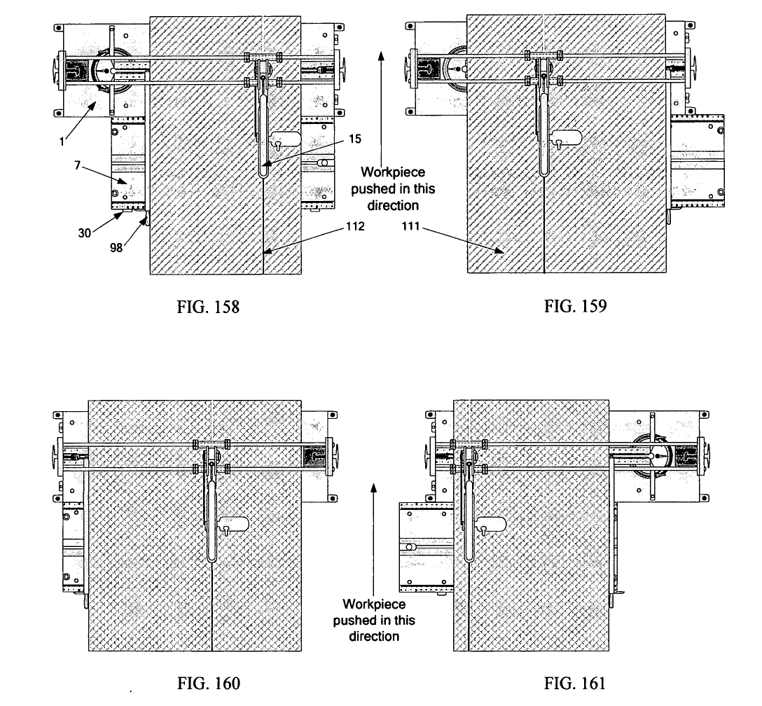

FIGS. 156-161 show the m Mach 50 setup for table saw operation. The extension platform 7 that is normally stowed underneath the main platform 1 can be attached to either side of the main platform 1 by using the extension support rods 30. The extension platform 7 can slide from end-to-end before the extension platform 7 is aligned.

The table saw can be used to cut the materials and sheets of large sizes in both directions as shown in the figures. The workpiece 111 is manually pushed against the cutting blade 17 while it is biased to the rip fence 98 sidewise. The rip fence 98 ensures the straight travel of the workpiece while it is pushed against the circular blade 17. As mentioned earlier, the laser line 112 can be turned ON before and during all cutting operations

### Circular Saw

While the m Mach 50 is capable of operating in the above mentioned modes, it does not stop the personnel from taking its sub-engine 64 completely out of the machine 50 for added use.

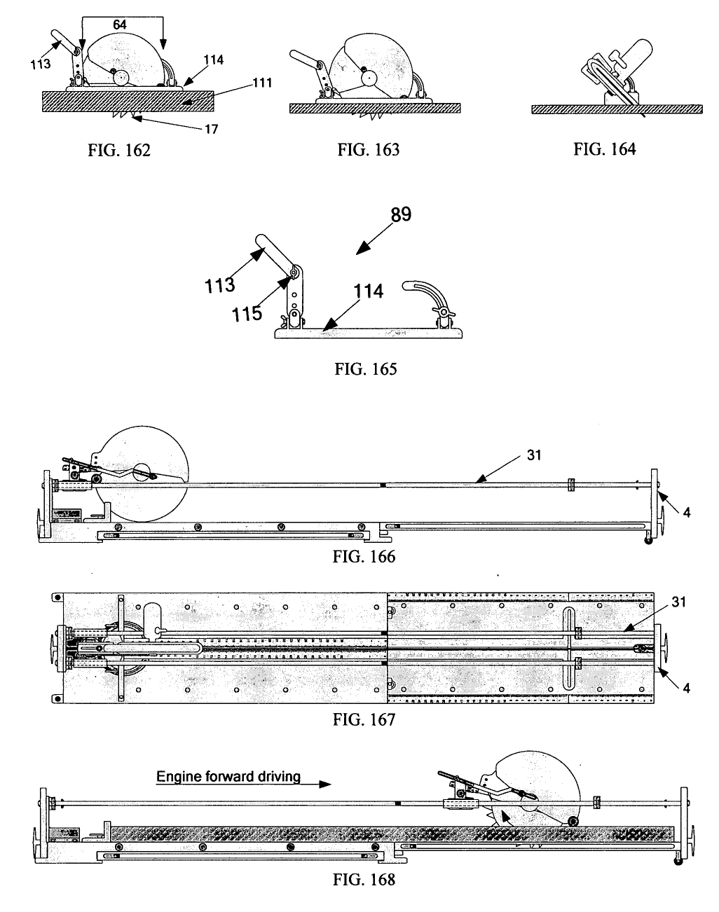

Refer to FIGS. 162-165. The sub-engine 64 alone can be used as a circular saw for the cutting all type of materials (111). As mentioned earlier, an auxiliary “Integrated handle with bevel-cum-cutting depth adjustment” 89 attachment is used that can be either permanently fixed to the sub-engine 64 (for small size engines 15) or snapped-in only when the engine 15 is used as a circular saw. The handle 113 can be adjusted as desired and the bevel plate 114 can be adjusted to set the bevel angle and the blade depth. The diameter of the cutting blade 17 must be within the safe and comfort operation limits for effectively using the sub-engine 64 as a circular saw.

### Extended Operations

### Extending the Dead-End of m Mach

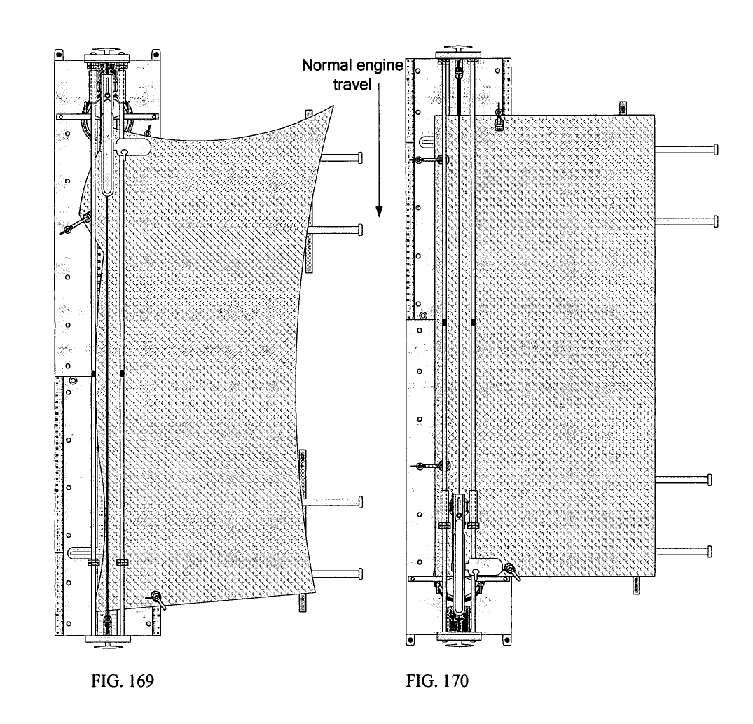

FIGS. 166-170 show the m Mach 50 with its dead-end 14 extended. The extension platform 7 that is designed for multipurpose use makes it possible to extend the operation of the m Mach 50 considerably. The dead-end bevel mechanism 4 and the extension guide rails 31 are connected as shown in the FIG. to operate the m Mach 50 in extended mode to perform various operations explained earlier in this document.

### Operating m Mach in the Absence of Dead-End Bevel Mechanism

To further enhance the operation of the m Mach 50 in table saw configuration, provision exists to completely takeout the bevel mechanism fitted at the dead-end 14.

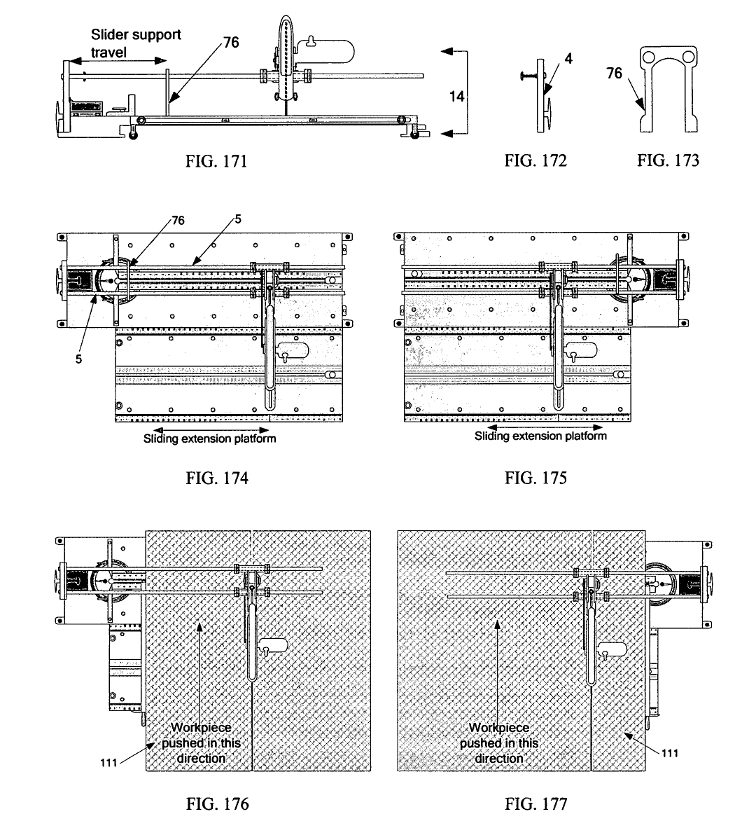

Refer to FIGS. 171-177. Increase in the performance of the m Mach 50 can be achieved in special cases with the absence of the dead-end bevel mechanism 4. One such case is to cut exceptionally larger workpieces when the m Mach 50 is used in the table saw configuration with the dead-end 14 bevel assembly absent as shown in FIGS. 174-175. Though it is not mandatory, such provision can help in many ways. In order to achieve this, the home-end bevel mechanism 3 must be designed to take care of complete counterbalance weight of the engine 15 and the guide rails 5 and their related assembly. This ensures that the m Mach 50 works as usual irrespective of the presence or absence of the dead-end bevel mechanism 4. To provide further stability and exceptional load support under this configuration, the m Mach 50 is equipped with an additional slider support 76 that can be slid-out from its home position and set at the required place underneath the guide rails 5. FIG. 173 shows the front elevation view of the slider support 76. The slider support can be easily slid back to its home position when it is not needed. FIGS. 176-177 show the m Mach 50 cutting large workpiece 111 in the absence of dead-end bevel mechanism 4.

### Stand/Pedestals for m Mach

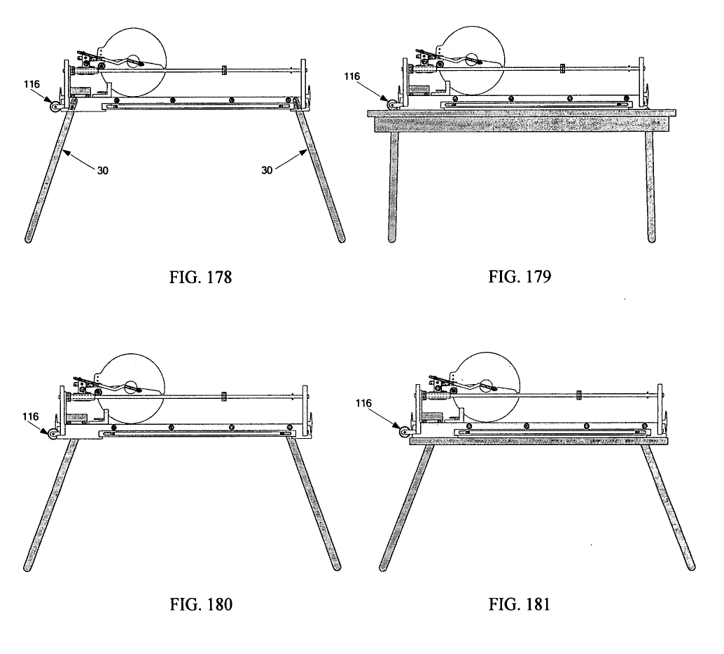

FIGS. 178-181 show m Mach 50 mounted on different type of stands and pedestals. Note that the stowed-in extension support rods 30 that are used for supporting the large workpieces can also be used as support legs as shown in FIG. 178. By default, all m Mach's 50 will have a pair of wheels 116 at the home-end of the machine 50 as shown in the figures for easy transportation.

### Drawings

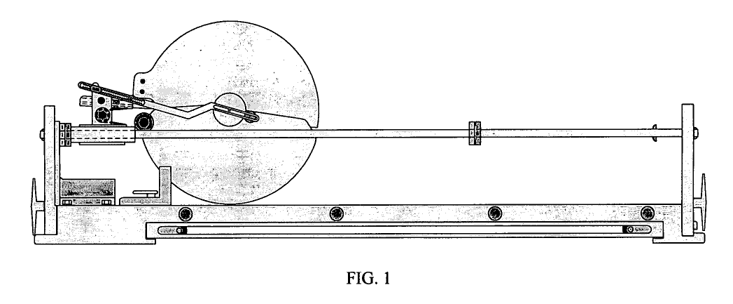

FIGS. 1-181 enclosed at the end of the specification pages.

What is claimed is:

1. A multipurpose method for cutting various materials, such as workpiece or sheet of material, comprising:
a circular or rotating cutting means driven by an engine, wherein said engine is powered by an electric power source.
a platform or a work surface means of sufficient size to accommodate for placing said material, wherein said platform has a linear grove, wherein said circular cutting means is moved linearly within said linear grove against said material placed on said platform.
one or more guide rail means on which said engine slides from one end to the other end and vice-versa, wherein said engine is held by said guide rail means for cutting said material by said circular means.
at least one bevel means located at the ends of said platform means, wherein said guide rails are held by said bevel means, wherein said bevel means, said guide rail means, and said engine work in unison for beveling said circular cutting means for setting the required bevel cutting angle with respect to flat surface (horizontal plane) of said platform means for bevel cutting of said material.
at least one miter means, such as turn-around miter fence, for setting the miter cutting angles with respect to the linear movement of said circular cutting means, wherein said material placed on said platform means is biased against said miter means during cutting operations.

2. A multipurpose cutting method for cutting various materials, such as workpiece or sheet of material, wherein the device is configured to operate in at least one of the following configurations to cut said materials in normal or bevel angles:
a straight or through cutting machine, wherein said material is kept in the cutting path, while optionally biased against a miter means set at a desired angle with respect to said cutting path, wherein a circular cutting means is moved against said material along the length of said material to perform the desired cutting operation on said material.
a straight-side creator or straight-side generator for creating straight sides on said material that has one or more uneven sides, wherein one of said uneven sides of said material is placed in said cutting path of said circular cutting means, wherein said uneven side is trimmed to create a perfect side, wherein said perfect side can be used as a reference for straightening other said uneven sides or for biasing against said miter means or rip fence for subsequent cutting operations.
a compound miter cutting machine, wherein said machine is used as a Fixed Rails Compound Miter (FR Miter), wherein said material is kept in said cutting path while biased against said miter means set at a desired angle with respect to said cutting path, wherein said circular cutting means is beveled at a required angle and is moved against said material to perform the desired cutting operation.
a cross cutter or a chop saw, wherein said circular cutting means, set at required bevel angle, is moved against the width of said material, wherein said material is biased against said miter means at a required miter angle to the cutting path to make perfect cross cut or chop cut along the width of said material.
a table-saw, wherein said circular means of said device is set at +/−90° with respect to the normal cutting path to operate said device in table saw configuration, wherein said material, while optionally biased against a fence sidewise, is manually pushed against said circular cutting means to perform the cutting operation on said material.
a circular saw, wherein the sub-engine is taken out of rest of the device to operate said sub-engine as a circular saw with the attachment of an integrated handle with bevel-cum-cutting depth adjustment means wherein the handle and the bevel plate of said integrated handle with bevel-cum-cutting depth adjustment means can be set at desired position to perform various cutting operations.

3. A multipurpose method for cutting various materials, such as workpiece or sheet of material, comprising an integrated slider-cum-multifunction mechanism means that slides on one or more parallel guide rails while the sub-engine is held by said integrated slider-cum-multifunction mechanism means comprising at least one of the following:
integrated slider means that slides on one or more said parallel guide rails, wherein rest of the engine is mounted on said integrated slider means, wherein said engine is pushed away or pulled towards the device operator to move said engine from one end to the other end and vice-versa while said integrated slider means is held by the guide rails.
engine depress and lift-up mechanism means for depressing and lifting-up said engine and hence the circular cutting means, wherein one end of said engine is held by a spring loaded auto retractable pivot mechanism means mounted on said integrated slider means, wherein said engine can be locked at a desired position, during depressing and lifting-up of said engine, with the help of a suitable locking means.
engine twisting mechanism means used for twisting or turning-around said engine and hence said circular cutting means, wherein said engine is turned-around in 360° directions in horizontal plane to set said engine in forward or reverse driving modes when said engine is set at 0° or 180° respectively, or in table saw operation modes when said engine is set at +/−90° degrees.
engine stretch and contract mechanism means by which the sub-engine is moved forward or backward within said integrated slider-cum-multifunction mechanism means to align the circular cutting blades of different sizes to fit within the linear grove of the platform or work surface means.
engine insert and release mechanism means that is used for completely taking out said sub-engine alone from rest of the integrated slider-cum-multifunction mechanism means when said sub-engine is used as a circular saw.

4. The integrated slider-cum-multifunction mechanism means of claim 3, wherein a lever mechanism means is used to set the position of the auto-retractable safety blade guard depending on the distance of the integrated slider-cum-multifunction mechanism means from said circular cutting means, wherein said safety blade guard steadily opens or closes as the circular cutting means is pushed down or lifted-up during cutting operations.

5. The circular saw of claim 3, wherein an integrated handle with bevel-cum-cutting depth adjustment means is attached to said sub-engine, wherein said integrated handle with bevel-cum-cutting depth adjustment means is used to set desired holding position
